(19) United States
(12) Patent Application Publication
(10) Pub. No.: US 2025/0160248 A1
(43) Pub. Date: May 22, 2025

(54) GARDEN TOOL AND CONTROL METHOD AND SYSTEM THEREOF

(71) Applicant: Greenworks (Jiangsu) Co., Ltd, Changzhou (CN)

(72) Inventors: Xian Zhuang, Changzhou (CN); Huage Wang, Changzhou (CN); Yanliang Zhu, Changzhou (CN); Zhiyuan Li, Changzhou (CN)

(21) Appl. No.: 19/034,765

(22) Filed: Jan. 23, 2025

Related U.S. Application Data
(63) Continuation of application No. PCT/CN2023/108273, filed on Jul. 20, 2023.

(30) Foreign Application Priority Data
Jul. 27, 2022 (CN) 202210893501.1
Jul. 29, 2022 (CN) 202210913806.4
Aug. 15, 2022 (CN) 202210978357.1
Aug. 15, 2022 (CN) 202210978359.0
Sep. 16, 2022 (CN) 202211133759.8
Nov. 3, 2022 (CN) 202211368522.8
Dec. 26, 2022 (CN) 202211679782.7

(51) Int. Cl. A01D 34/00; G01S 19/48; G05D 1/648; G05D 105/00; G05D 105/15

(52) U.S. Cl. CPC A01D 34/008; G01S 19/48; G05D 1/648; G05D 2105/12; G05D 2105/15

(57) ABSTRACT

A control method of a garden tool includes arranging a target marker as a positioning marker in a satellite navigation shadowed area in a working area of the garden tool, the garden tool is positioned based on a satellite navigation signal and a working area map in an area with reliable satellite signals outside the satellite navigation shadowed area. In the satellite navigation shadowed area, the garden tool is positioned through identifying the target marker in the satellite navigation shadowed area by an identification scanning module, thereby improving working efficiency of the garden tool in the satellite navigation shadowed area.

### CROSS REFERENCE TO RELATED APPLICATION

The present application is a continuation Application of PCT application No. PCT/CN2023/108273 filed on Jul. 20, 2023, which claims the benefit of CN202211133759.8 filed on Sep. 16, 2022, CN202210978359.0 filed on Aug. 15, 2022, CN202210978357.1 filed on Aug. 15, 2022, CN202210913806.4 filed on Jul. 29, 2022, CN202210893501.1 filed on Jul. 27, 2022, CN202211368522.8 filed on Nov. 3, 2022 and CN202211679782.7 filed on Dec. 26, 2022. All the above are hereby incorporated by reference for all purposes.

### TECHNICAL FIELD

The disclosure relates to a technical field of garden tools, particular to a garden tool and a control method and a system thereof.

### BACKGROUND

RTK (Real-time kinematic) carrier phase differential technology is a method for real-time processing of the differential carrier phase observations of two measuring stations. The carrier phase collected by the base station is sent to the user receiver to calculate the difference coordinates. RTK is a satellite positioning measurement method that can obtain centimeter-level positioning accuracy in real time in the wild. RTK differential positioning technology has been widely used in various garden tools such as robotic mowers.

When garden tools such as robotic mowers based on satellite signal navigation are working, some satellite navigation shadowed areas (also called satellite signal shadowed areas) where satellite signals are poor or easily lost will be formed in the working area of the garden tools due to obstructions such as buildings, roofs, sheds, trees, garden umbrellas, awnings, leaves, etc. in or near the working area. When the garden tool enters the satellite navigation shadowed areas, the position of the garden tool cannot be reliably determined based on the satellite navigation positioning module receiving the satellite signal, thereby affecting the normal operation of the garden tool in the satellite navigation shadowed areas.

### SUMMARY

The disclosure provides a garden tool and a control method and a system thereof, so that the garden tool can be accurately positioned even in a satellite navigation shadowed area.

The disclosure provides the control method of the garden tool, and the control method includes operations as follows.

A working area map of the garden tool is obtained, the working area map includes a satellite navigation shadowed area, and a target marker identified by an identification scanning module is arranged in the satellite navigation shadowed area.

The garden tool is positioned based on the satellite navigation signal and the working area map when the garden tool is in an area with reliable satellite signals outside the satellite navigation shadowed area.

The garden tool is positioned through identifying the target marker in the satellite navigation shadowed area through the identification scanning module when the garden tool is in the satellite navigation shadowed area.

In an embodiment of the disclosure, a plurality of the target markers identified by the identification scanning module is arranged in the satellite navigation shadowed area, and the plurality of the target markers is arranged according to a preset position relationship.

The garden tool is positioned through identifying and positioning the target marker in the satellite navigation shadowed area through the identification scanning module when the garden tool in in the satellite navigation shadowed area includes operations as follows.

When the garden tool enters the satellite navigation shadowed area, based on the preset position relationship, the target marker is identified by the identification scanning module to obtain a first position and first distance data of the target marker relative to the garden tool.

Position information of the garden tool is calculated according to the first position and the first distance data of the target marker relative to the garden tool according to the position information of the target marker position of the garden tool in the satellite navigation shadowed area.

In an embodiment of the disclosure, when the garden tool enters the satellite navigation shadowed area, based on the preset position relationship, identifying the target marker by the identification scanning module to obtain a first position and first distance data of the target marker relative to the garden tool includes operations as follows.

First positions and first distance data of a plurality of the obstacles including the target marker relative to the garden tool are obtained through the identification scanning module.

A position relationship between the obstacles is calculated according to the first positions and the distance data of the plurality of obstacles relative to the garden tool.

Based on the position relationship between the obstacles, several obstacles satisfying the preset position relationship are found from the plurality of obstacles as the target markers.

In an embodiment of the disclosure, three target markers identified by the identification scanning module are arranged in the satellite navigation shadowed area, the three target markers are arranged in a triangle, and the preset position relationship refers to a distance between any two of the target markers.

In an embodiment of the disclosure, the working area map further includes marker matching areas, and each of the marker matching areas is arranged around a periphery of the satellite navigation shadowed area.

In the satellite navigation shadowed area, the garden tool is positioned through identifying and positioning the target marker in the satellite navigation shadowed area through the identification scanning module includes operations as follows.

A surrounding environment of the garden tool is scanned through the identification scanning module to obtain scanning information.

The scanning information is matched with marker feature information in the marker matching area corresponding to the satellite navigation shadowed area to identify the target marker in the satellite navigation shadowed area.

The garden tool in the satellite navigation shadowed area is positioned based on the identified target marker.

In an embodiment of the disclosure, positioning the garden tool in the satellite navigation shadowed area based on the identified target marker includes operations as follows.

A second position and second distance data of the identified target marker relative to the garden tool is obtained through the identification scanning module.

A position of the garden tool in the satellite navigation shadowed area is estimated based on the second position and second distance data of the identified target marker relative to the garden tool and based on position information of the identified target marker to achieve a positioning of the garden tool in the satellite navigation shadowed area.

In an embodiment of the disclosure, the marker matching area is a rectangular marker matching area or a circular marker matching area.

In an embodiment of the disclosure, the control method of the garden tool includes operations as follows.

When the garden tool enters the marker matching area, the garden tool enters a ready state.

The garden tool obtains a relative position of the target marker based on the position information of the target marker in the marker matching area and based on position information of the garden tool.

When the garden tool moves further and enters the satellite navigation shadowed area in the marker matching area, a predicted position of the target marker is obtained based on the relative position of the target marker, a moving direction and a speed of the garden tool.

A preset range on two sides of the predicted position is scanned through the identification scanning module to obtain the scanning information.

The scanning information is matched with marker feature information in the marker matching area to identify the target marker in the satellite navigation shadowed area.

The garden tool in the satellite navigation shadowed area is positioned based on the identified target marker.

In an embodiment of the disclosure, the control method of the garden tool further includes operations as follows.

Based on the working area map, the garden tool is controlled to walk around an edge of the satellite navigation shadowed area, the position information of the satellite navigation shadowed area is collected and saved, and the satellite navigation shadowed area is identified in the working area map.

In an embodiment of the disclosure, positioning the garden tool based on the satellite navigation signal and the working area map in an area with reliable satellite signals outside the satellite navigation shadowed area includes operations as follows.

In the area with reliable satellite signals outside the satellite navigation shadowed area, a movement of the garden tool is controlled based on a real-time kinematic differential positioning signal and the working area map.

In an embodiment of the disclosure, the control method of the garden tool further includes operations as follows.

In the area with reliable satellite signals outside the satellite navigation shadowed area, the target marker is identified through the identification scanning module to obtain a third position and distance data of the target marker relative to the garden tool.

Position information of the target marker is calculated according to the third position and the third distance data of the target marker relative to the garden tool and according to position information of the garden tool.

In an embodiment of the disclosure, the identification scanning module includes a visual recognition module or a radar recognition module, and the radar recognition module includes a laser radar recognition module or a millimeter wave radar module.

In an embodiment of the disclosure, the garden tool includes mowers or snow throwers.

The disclosure provides the control system of the garden tool, and the control system includes a map acquisition module, a satellite positioning module and a shadowed area positioning module.

The map acquisition module is configured to obtain a working area map of the garden tool, a satellite navigation shadowed area is marked in the working area map, and a target marker identified by an identification scanning module is arranged in the satellite navigation shadowed area.

The satellite positioning module is configured to position the garden tool based on the satellite navigation signal and the working area map in an area with reliable satellite signals outside the satellite navigation shadowed area.

The shadowed area positioning module is configured to position the garden tool through identifying the target marker in the satellite navigation shadowed area through the identification scanning module in the satellite navigation shadowed area.

In an embodiment of the disclosure, a plurality of target markers identified by the identification scanning module are arranged in the satellite navigation shadowed area, and the plurality of the target markers are arranged according to a preset position relationship.

The target positioning module includes a first identification module and a first position calculation module.

The first identification module is configured to identify the target marker by the identification scanning module to obtain a first position and first distance data of the target marker relative to the garden tool based on the preset position relationship when the garden tool enters the satellite navigation shadowed area.

The first position calculation module is configured to calculate position information of the garden tool according to the first position and the first distance data of the target marker relative to the garden tool according to position information of the target marker to position the garden tool in the satellite navigation shadowed area.

In an embodiment of the disclosure, the working area map is further marked with marker matching areas, and each of the marker matching areas is arranged around a periphery of the satellite navigation shadowed area. The shadowed area positioning module includes a scanning information acquisition module, a second identification module and a second position calculation module.

The scanning information acquisition module is configured to scan a surrounding environment of the garden tool through the identification scanning module to obtain scanning information.

The second identification module is configured to match the scanning information with marker feature information in the marker matching area corresponding to the satellite navigation shadowed area to identify the target marker in the satellite navigation shadowed area.

The second position calculation module is configured to position the garden tool in the satellite navigation shadowed area based on the identified target marker.

The disclosure provides the garden tool, and the control system includes a storage module, a positioning module, an identification scanning module and a control module.

The storage module is configured to store a working area map of the garden tool.

The positioning module is configured to position the garden tool based on a satellite navigation signal.

The identification scanning module is configured to recognize a target marker and obtain a position and a distance of the target marker relative to the garden tool.

The control module is configured to:
obtain the working area map of the garden tool, a satellite navigation shadowed area being marked in the working area map, and a target marker identified by an identification scanning module being arranged in the satellite navigation shadowed area;
position the garden tool based on the satellite navigation signal and the working area map in an area with reliable satellite signals outside the satellite navigation shadowed area; and
position the garden tool through identifying the target marker in the satellite navigation shadowed area through the identification scanning module in the satellite navigation shadowed area.

In an embodiment of the disclosure, the identification scanning module includes a visual recognition module or a radar recognition module, and the radar recognition module includes a laser radar recognition module or a millimeter wave radar module.

In an embodiment of the disclosure, the garden tool further includes a path planning module, and the path planning module is configured to plan a path according to the working area map of the garden tool.

In an embodiment of the disclosure, the garden tool includes mowers or snow thrower.

The disclosure provides the garden tool and the control method and a system thereof. Through the area with reliable satellite signals outside the satellite navigation shadowed area, the garden tool is positioned based on the satellite navigation signal and the working area map. In the satellite navigation shadowed area, the garden tool is positioned through identifying the target marker in the satellite navigation shadowed area by an identification scanning module, thereby improving working efficiency of the garden tool in the satellite navigation shadowed area.

The garden tool and the control method and the system of the garden tool of the disclosure mark the satellite navigation shadowed area and the marker matching area in the working area map of the garden tool, and set the marker matching area around the periphery of the satellite navigation shadowed area. Through setting the marker matching area, when the target marker in the satellite navigation shadowed area is identified by the identification scanning module for positioning, a matching area when identifying the target marker can be narrowed, thereby reducing an amount of calculation and improving positioning accuracy and efficiency.

### BRIEF DESCRIPTION OF THE DRAWINGS

FIG. 1 is a schematic view of RTK differential positioning method.

FIG. 2 is a first structural block view of a mower according to at least one embodiment of the disclosure.

FIG. 3 is a first schematic flowchart of a control method of the mower according to at least one embodiment of the disclosure.

FIG. 4 is a first arrangement schematic view of a target marker in a satellite navigation shadowed area according to at least one embodiment of the disclosure.

FIG. 5 is a schematic view of a laser radar or a millimeter wave radar module identifying obstacles according to at least one embodiment of the disclosure.

FIG. 6 is a schematic view of obtaining position information of the target marker in an open area outside the satellite navigation shadowed area according to at least one embodiment of the disclosure.

FIG. 7 is a schematic view of a positioning in the satellite navigation shadowed area based on the target marker according to least one embodiment of the disclosure.

FIG. 8 is a functional block view of a control system of a first mower according to least one embodiment of the disclosure.

FIG. 9 is a second schematic flowchart of the control method of the mower according to at least one embodiment of the disclosure.

FIG. 10 is a second arrangement schematic view of a target marker in a satellite navigation shadowed area according to least one embodiment of the disclosure.

FIG. 11 is a schematic view of defining a matching area around the satellite navigation shadowed area according to least one embodiment of the disclosure.

FIG. 12 is a sub flowchart of S230 according to least one embodiment of the disclosure.

FIG. 13 is a functional module of a control system of a second mower according to least one embodiment of the disclosure.

FIG. 14 is a second structural block view of the mower according to at least one embodiment of the disclosure.

FIG. 15 is a schematic flowchart of a method for setting a temporary restricted area in a working area map according to at least one embodiment of the disclosure.

FIG. 16 is a schematic view of an actual working area of the mower and a working area map displayed on a mobile terminal according to at least one embodiment of the disclosure.

FIG. 17 is a schematic view of the mower moving to a target position where the temporary restricted area needs to be set up in an actual working area, and determining a position of the mower in the working area map displayed on the mobile terminal according to at least one embodiment of the disclosure.

FIG. 18 is a schematic view of selecting a preset rectangle in the working area map displayed on the mobile terminal to set the temporary restricted area according to at least one embodiment of the disclosure.

FIG. 19 is a schematic view of selecting a preset circle in the working area map displayed on the mobile terminal to set the temporary restricted area according to at least one embodiment of the disclosure.

FIG. 20 is a schematic view of manually drawing the temporary restricted area in the working area map displayed on the mobile terminal according to at least one embodiment of the disclosure.

FIG. 21 is a functional module view of a setting system of the temporary restricted area in the working area map according to at least one embodiment of the disclosure.

FIG. 22 and FIG. 23 are schematic views of a method for detecting the mower leaving a ground according to at least one embodiment of the disclosure.

FIG. 24 is a flowchart of the method for detecting the mower leaving the ground according to at least one embodiment of the disclosure.

FIG. 25 is a flowchart of a method for obtaining a position of the mower according to at least one embodiment of the disclosure.

FIG. 26 is a flowchart of a slope calculation method according to at least one embodiment of the disclosure.

FIG. 27 is a flowchart of a safety control method of the mower according to at least one embodiment of the disclosure.

FIG. 28 is a functional module block view of a mower ground-lift detection device according to at least one embodiment of the disclosure.

FIG. 29 is a structural block view of a control system of the mower for detecting the mower leaving the ground according to at least one embodiment of the disclosure.

FIG. 30 is a schematic flowchart of a method for guiding the mower to a predetermined position according to at least one embodiment of the disclosure.

FIG. 31 is a schematic view of an applied condition of the method for guiding the mower to the predetermined position according to at least one embodiment of the disclosure.

FIG. 32 is a third structural block view of the mower according to at least one embodiment of the disclosure.

FIG. 33 is a structural block view of a regressive walking control system of the mower according to at least one embodiment of the disclosure.

FIG. 34 is a schematic flowchart of obtaining the position of the mower according to at least one embodiment of the disclosure.

FIG. 35 is a schematic flowchart of determining a position of a charging station according to at least one embodiment of the disclosure.

FIG. 36 is a schematic flowchart of generating a first area and a guiding point according to at least one embodiment of the disclosure.

FIG. 37 is a first application view of a calibration method of navigation information of the mower according to at least one embodiment of the disclosure.

FIG. 38 is a schematic view of a map offset according to at least one embodiment of the disclosure.

FIG. 39 is a flowchart of the calibration method of the navigation information of the mower according to at least one embodiment of the disclosure.

FIG. 40 is a flowchart of a method for correcting RTK positioning information according to at least one embodiment of the disclosure.

FIG. 41 is a detailed flowchart of the calibration method of the navigation information of the mower according to at least one embodiment of the disclosure.

FIG. 42 is a second application view of the calibration method of the navigation information of the mower according to at least one embodiment of the disclosure.

FIG. 43 is a flowchart of a determination method of a base station mobile event of an embodiment shown in FIG. 42.

FIG. 44 is a detailed flowchart of the calibration method of the navigation information of the mower of the embodiment shown in FIG. 42.

FIG. 45 is a functional module block view of a navigation information calibration device of the mower according to at least one embodiment of the disclosure.

FIG. 46 is a schematic view of a calibration device of the mower according to at least one embodiment of the disclosure.

FIG. 47 is a schematic flowchart of a calibration method of the mower according to at least one embodiment of the disclosure.

FIG. 48 is a detailed schematic flowchart of the calibration method of the mower according to at least one embodiment of the disclosure.

FIG. 49 is a schematic view of a mower offset to a right according to at least one embodiment of the disclosure.

FIG. 50 is a schematic view of a mower offset to a left according to at least one embodiment of the disclosure.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure.

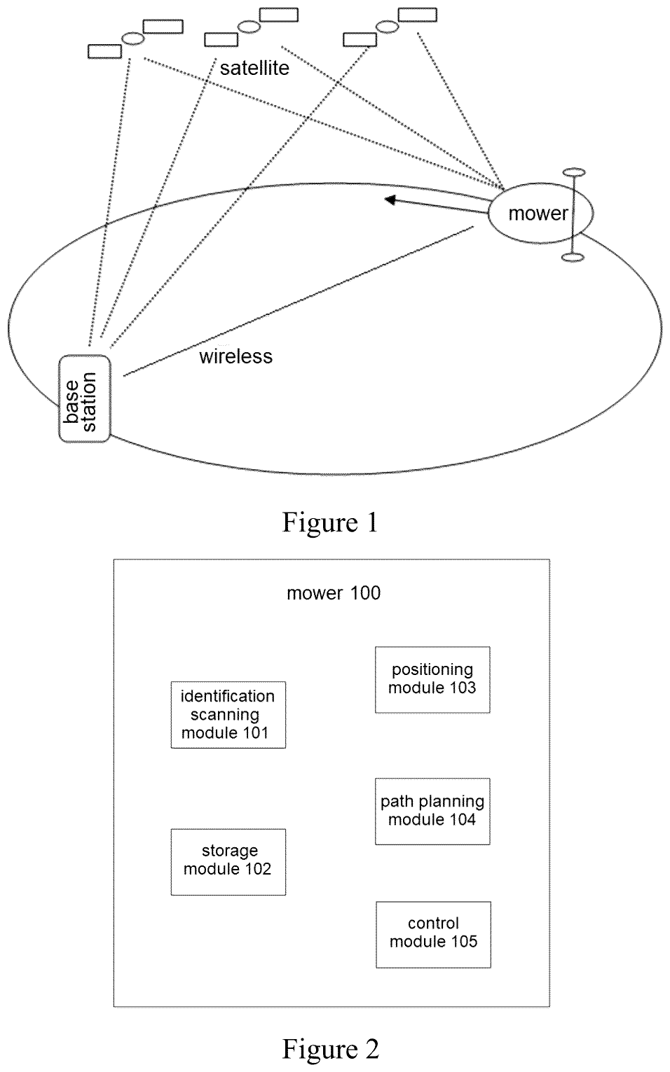

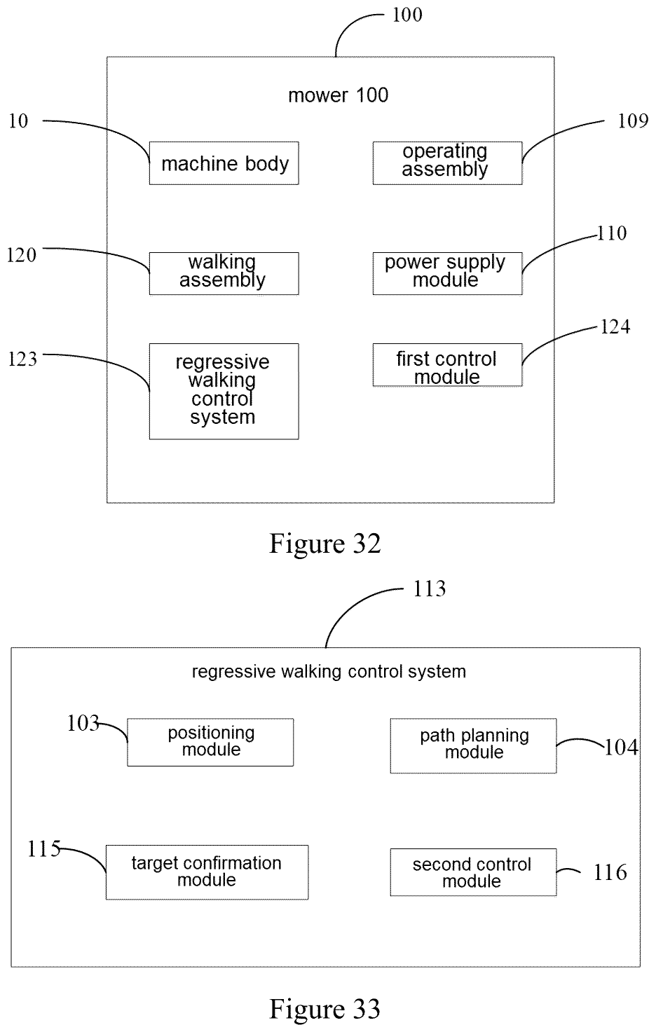

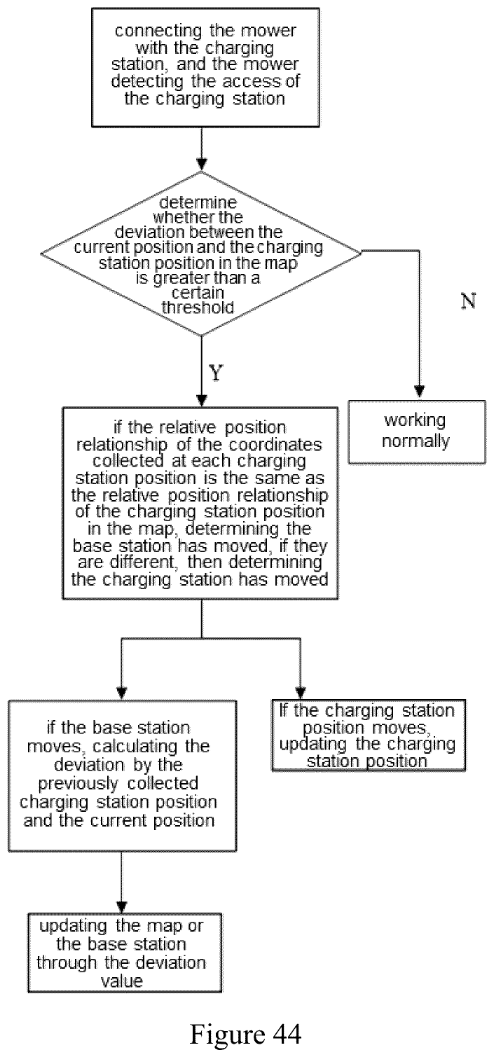

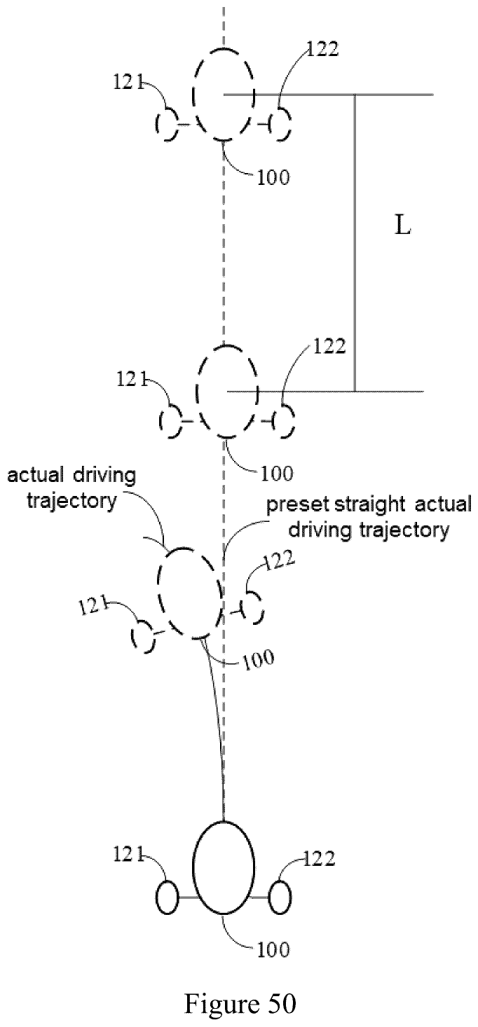

Please refer to FIG. 1 through FIG. 50. It should be noted that drawings provided in the embodiments are only illustrative of a basic idea of the disclosure. The drawings only show assemblies related to the disclosure instead of drawing according to the number, shape and size of the assemblies in actual implementation. In actual implementation, the type, quantity and ratio of each assembly may be changed at will, and a layout of the assemblies may also be more complicated.

In order to improve positioning accuracy, garden tools such as mowers, snow throwers, string trimmers, and hedge trimmers usually use RTK differential positioning technology as shown in FIG. 1 for positioning. RTK differential positioning technology is a real-time differential GPS technology based on carrier phase observation. It includes three parts: reference station receiver, data link, and rover receiver. Receivers of the carrier reference station and the rover continuously monitor a same satellite, and when the rover receives and observes visible satellite signals, the reference station sends a carrier phase measurement value to the rover receiver in real time through the data link. The rover receiver processes its own carrier phase measurement value and the received carrier phase measurement value in real time to calculate its own spatial coordinates and complete a high-accuracy positioning. A positioning accuracy of the carrier phase difference may reach a centimeter level. In FIG. 1, a base station is configured as a reference station, and a mower is configured as a rover. This disclosure will be described using the mower as an example.

Please refer to FIG. 2. The mower 100 includes an identification scanning module 101, a storage module 102, a positioning module 103, a path planning module 104 and a control module 105.

The identification scanning module 101 may identify objects in a working area and position information of the objects relative to the mower 100. The identification scanning module 101 may be a visual recognition module such as a camera, or a radar recognition module, and the radar recognition module may be a laser radar recognition module or a millimeter wave radar module. The storage module 102 is used to store a working area map of the mower 100 and related computer programs. The positioning module 103 can position the mower 100 based on satellite navigation signals. As an example, the positioning module 103 may position the mower 100 based on the RTK differential positioning technology as shown in FIG. 1. The path planning module 104 is used to plan a working path of the mower 100 in the working area according to the working area map of the mower 100. For the same working area map, path planning may be performed based on different traveling angles and working widths, thereby forming a working area map with different paths. The control module 105 is used to coordinate each module to work and control a movement of walking components of the mower 100 to perform moving operations based on navigation positioning information.

Some satellite navigation shadowed areas where satellite signals are poor or easily lost will be formed in the working area of the mowers due to obstructions such as buildings, roofs, sheds, trees, garden umbrellas, awnings, leaves, etc. in or near the working area. When the mowers enters the satellite navigation shadowed areas, the position of the mower cannot be reliably determined based on the positioning module 103 receiving the satellite signals, thereby affecting a normal operation of the mower in the satellite navigation shadowed areas.

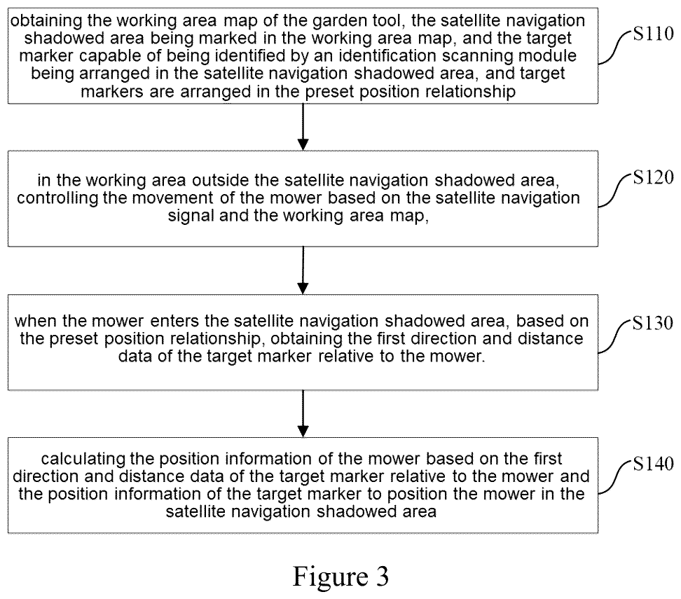

Please refer to FIG. 3. A control method of the mower includes operations as follows.

First, execute S110: obtaining a working area map of the garden tool, a satellite navigation shadowed area being marked in the working area map, and a target marker identified by an identification scanning module being arranged in the satellite navigation shadowed area. In an embodiment, a plurality of target markers identified by the identification scanning module 101 is arranged in the satellite navigation shadowed area, and the plurality of target markers are arranged according to a preset position relationship.

There are many ways for the mower 100 to obtain the working area map. In an embodiment, the storage module 102 of the mower 100 stores the working area map, and the mower 100 may directly read the working area map from the storage module 102. In another embodiment, the mower 100 controls itself to move along a boundary wire of the working area, and uses the positioning module 103 to collect real-time position coordinates of the mower 100 and store the real-time position coordinates in the storage module 102 as the working area map. The positioning module 103 is, for example, a global positioning module 103. In another embodiment, the mower 100 may also communicate with an external terminal through a communication module and receive the working area map sent by the external terminal.

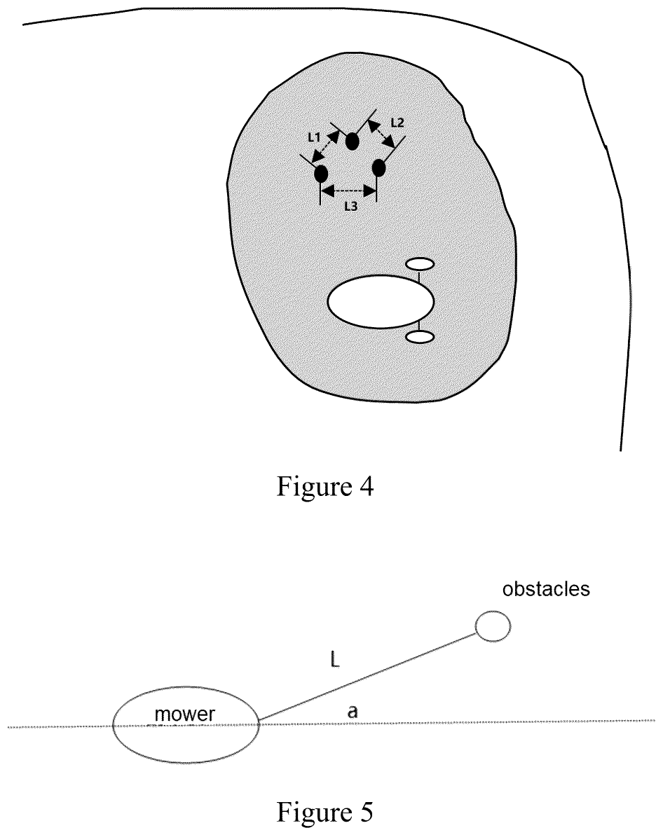

Please refer to FIG. 4. In order to solve a problem of the accurate positioning of the mower 100 in the satellite navigation shadowed area, it is necessary to mark the satellite navigation shadowed area (a gray area in FIG. 4) in the working area (an area defined by an outermost solid line in FIG. 4), and arrange a plurality of target markers (black dots in FIG. 4) that can be recognized by the radar recognition module in the satellite navigation shadowed area. Setting the target marker in the satellite navigation shadowed area can enable the target marker to be closer to the mower 100, which reduces a shielding of the target marker by other obstacles in the working area, and enables the mower 100 to accurately identify the target marker.

When a satellite navigation shadowed area is marked in the working area, the mower 100 can be controlled to walk around the satellite navigation shadowed area in the working area to collect and save position information of the satellite navigation shadowed area and mark it on the working area map, thereby dividing the working area into an open area and a satellite navigation shadowed area. The open area refers to an area with reliable satellite signals where the mower 100 can accurately position itself based on satellite navigation signals.

A plurality of target markers need to satisfy the preset position relationship so that the target markers can be accurately identified based on the preset position relationship, so as to perform the positioning based on the target markers in the satellite navigation shadowed area. Please refer to FIG. 4. Three target markers are arranged in the satellite navigation shadowed area, and the three target markers are arranged in a triangle. The preset position relationship refers to a distance between any two of the target markers, which are L1, L2 and L3 in FIG. 5 respectively. It may be understood that, in other embodiments, there may also be two or more than three target markers.

Then, execute S120: in the working area outside the satellite navigation shadowed area, controlling the movement of the mower based on the satellite navigation signal and the working area map, which means that in the area with reliable satellite signals outside the satellite navigation shadowed area, the mower is positioned based on the satellite navigation signal and the working area map.

In the open area of the working area, the mower 100 may utilize the positioning module 103 to use kinematic differential positioning technology based on the received satellite navigation signal to control the mower 100 to move along a planned path.

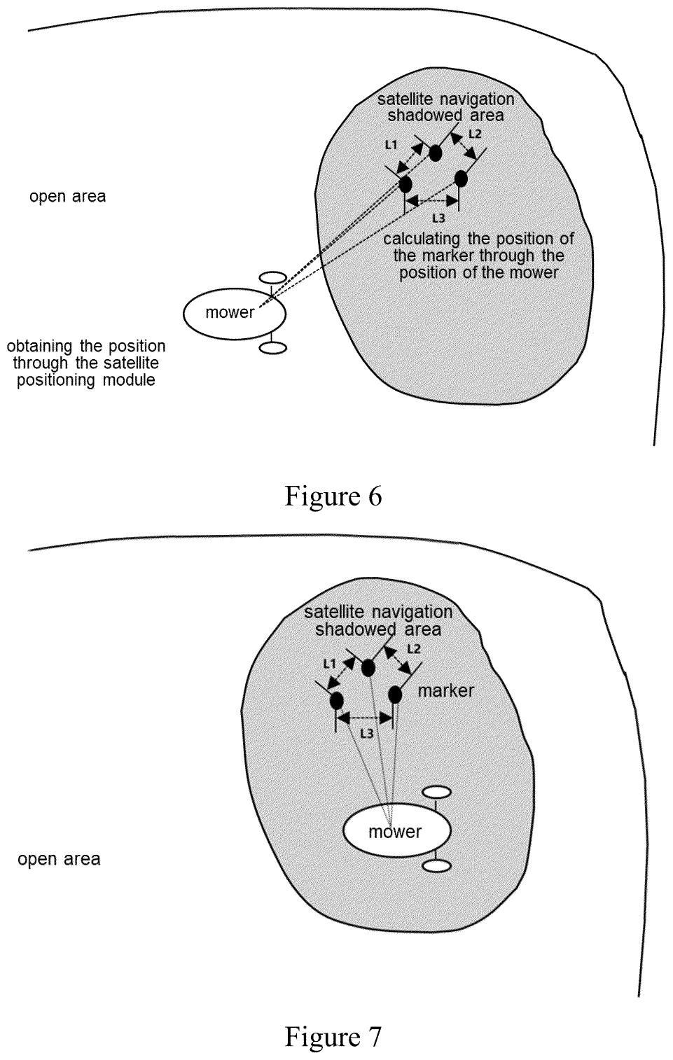

In the open area, please refer to FIG. 5 and FIG. 6. When determining the position information of the target marker, the mower 100 may identify the target marker through the radar recognition module based on the preset position relationship, and obtain a position α and a distance data L of the target marker relative to the mower 100 as a third position and distance data. Since the position information of the mower 100 is known, the position information of the target marker may be calculated based on the third position and the third distance data of the target marker relative to the mower 100 and based on the position information of the mower 100. It should be noted that, the position information of the target marker may be obtained each time a mowing operation is performed, or may be obtained during a first mowing operation and stored in the storage module 102 for subsequent use.

In an embodiment, when the mower 100 uses the radar recognition module to scan and identify the target marker, it will simultaneously obtain positions and distance data of a plurality of obstacles including the target marker relative to the mower 100. It is necessary to first calculate the position relationship between the obstacles based on the positions and distance data of the plurality of obstacles relative to the mower 100. Then, based on the position relationship between the obstacles, several obstacles that satisfy the preset position relationship are found from the plurality of obstacles. The found obstacles are the set target markers. Finally, the position information of the target marker is calculated by using the positions and distance data of the target marker relative to the mower 100 and the position information of the mower 100.

Please refer to FIG. 6. When the distances between any two of the three obstacles are L1, L2 and L3 respectively, the three obstacles may be considered as three target markers preset in the satellite navigation shadowed area.

Finally, execute S130 and S140: when the mower enters the satellite navigation shadowed area, based on the preset position relationship, the identification scanning module 101 is used to identify the target marker to obtain a first direction and distance data of the target marker relative to the mower. The position information of the mower is calculated based on the first direction and distance data of the target marker relative to the mower and the position information of the target marker to position the mower in the satellite navigation shadowed area. This means that in the satellite navigation shadowed area, the garden tool is positioned through identifying the target marker through the identification scanning module.

Please refer to FIG. 5 through FIG. 7. When the mower 100 moves in the open area of the working area, a real-time position of the mower 100 may be obtained based on the satellite navigation signal. When the mower 100 enters the satellite navigation shadowed area, the radar recognition module may be used to identify the target marker set in the satellite navigation shadowed area, and the position α and distance data L of the target marker relative to the mower 100 are obtained as the first position and first distance data.

In an embodiment, in the satellite navigation shadowed area, when the mower 100 uses the radar recognition module to scan and identify the target marker, it will simultaneously obtain positions and distance data of the plurality of obstacles including the target marker relative to the mower 100. It is necessary to first calculate the position relationship between the obstacles based on the positions and the distance data of the plurality of obstacles relative to the mower 100. Then, based on the position relationship between the obstacles, several obstacles that satisfy the preset position relationship are found from the plurality of obstacles. The found obstacles are the target markers. Since the position information of the target marker is known, the position information of the mower 100 can be calculated using the direction and distance data of the target marker relative to the mower 100 and the position information of the target marker, so as to position the mower 100 in the satellite navigation shadowed area.

Please refer to FIG. 7. When the distances between any two of the three obstacles are L1, L2 and L3 respectively, the three obstacles may be considered as three target markers preset in the satellite navigation shadowed area.

This solution sets the target markers as positioning markers in the satellite navigation shadowed area in the working area of the mower 100, and controls the movement of the mower 100 based on the satellite navigation signal and the working area map in the working area outside the satellite navigation shadowed area. When the mower 100 enters the satellite navigation shadowed area, the position information of the mower 100 is calculated based on the positions and distance data of the target markers relative to the mower 100 and the position information of the target marker, so as to position the mower 100 in the satellite navigation shadowed area, thereby improving working efficiency of the mower 100 in the satellite navigation shadowed area.

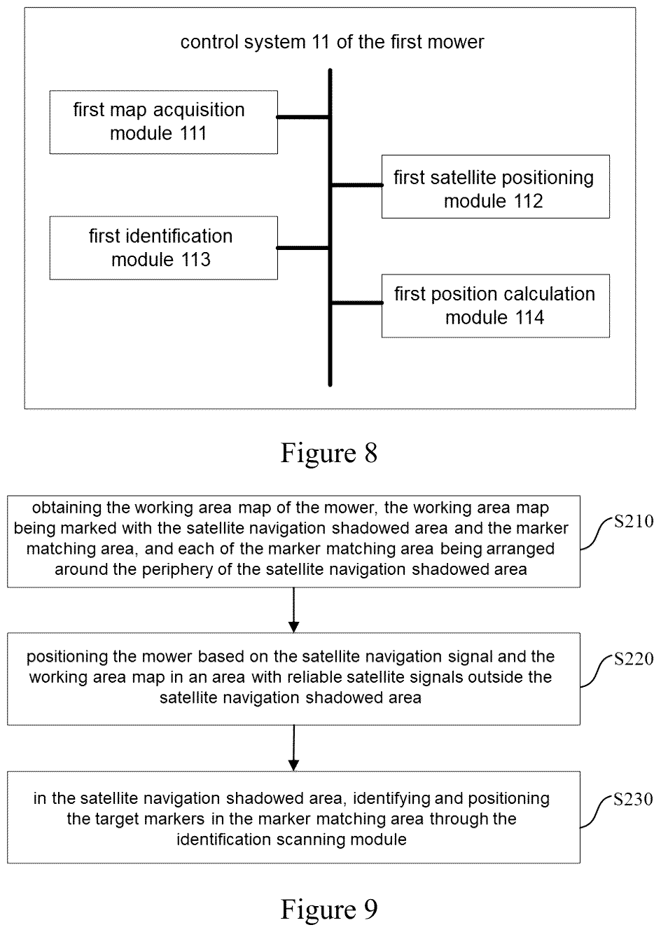

FIG. 8 is a functional module view of a control system 11 of a first mower of the disclosure. Please refer to FIG. 8. The control system 11 of the first mower includes a first map acquisition module 111, a first satellite positioning module 112 and a first shadowed area positioning module.

The first map acquisition module 111 is used to obtain the working area map of the mower. The satellite navigation shadowed area is marked in the working area map, and the target markers identified by an identification scanning module are arranged in the satellite navigation shadowed area. In an embodiment, the plurality of target markers identified by the identification scanning module 101 is arranged in the satellite navigation shadowed area, and the plurality of target markers is arranged according to the preset position relationship.

The first satellite positioning module 112 is configured to control the movement of the mower based on the satellite navigation signal and the working area map in a working area outside the satellite navigation shadowed area, which means the area with reliable satellite signals.

The first shadowed area positioning module is configured to position the garden tool through identifying the target markers in the satellite navigation shadowed area through the identification scanning module in the satellite navigation shadowed area.

The first shadowed area positioning module includes a first identification module 113 and a first position calculation module 114. The first identification module 113 is used to utilize the identification scanning module 101 to identify the target marker to obtain the first direction and the distance data of the target marker relative to the mower based on the preset position relationship when the mower enters the satellite navigation shadowed area. The first position calculation module 114 is used to calculate the position information of the mower based on the first direction and distance data of the target marker relative to the mower and the position information of the target marker to position the mower in the satellite navigation shadowed area.

It should be noted that, the control system 11 of the first mower of this embodiment is a system corresponding to the above control method of the mower, and the functional modules in the control system 11 of the first mower correspond to the corresponding operations in the control method of the mower respectively. The control system 11 of the first mower of this embodiment may be implemented in cooperation with the control method of the mower. Correspondingly, the control system 11 of the first mower of this embodiment may be implemented in cooperation with the control method of the mower.

Since there are many markers in the working area map of the mower, when identifying a specific marker, it is necessary to traverse all the markers in the working area map for matching, which is inefficient. In addition, when the markers are similar, the positioning is inaccurate, which affects the positioning accuracy and efficiency. Therefore, please refer to FIG. 9. Another control method of the mower is provided.

Please refer to FIG. 9. The control method of the mower includes operations as follows.

First, execute S210: obtaining the working area map of the mower. The working area map is marked with the satellite navigation shadowed area and a marker matching area, and each of the marker matching area is arranged around a periphery of the satellite navigation shadowed area. In an embodiment, the target marker identified by the identification scanning module is arranged in the satellite navigation shadowed area, and an area of the marker matching area is greater than or equal to an area of the satellite navigation shadowed area.

There are many ways for the mower 100 to obtain the working area map. In an embodiment, the storage module 102 of the mower 100 stores the working area map, and the mower 100 may directly read the working area map from the storage module 102. In another embodiment, the mower 100 controls itself to move along the boundary wire of the working area, and uses the positioning module 103 to collect the real-time position coordinates of the mower 100 and store them in the storage module 102 as the working area map. The positioning module 103 is, for example, the global positioning module 103. In another embodiment, the mower 100 may also communicate with the external terminal through the communication module and receive the working area map sent by the external terminal.

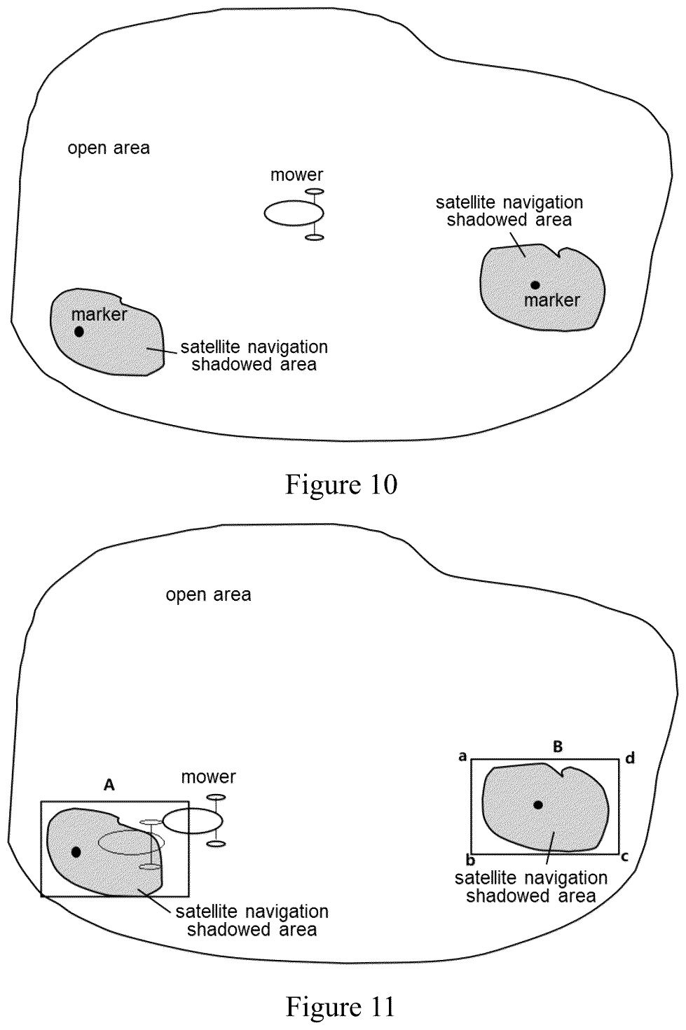

Please refer to FIG. 10. In order to solve the problem of the accurate positioning of the mower 100 in the satellite navigation shadowed area, it is necessary to mark the satellite navigation shadowed area (the gray area in FIG. 10 represents the satellite navigation shadowed area) in the working area (an area defined by an outermost solid line in FIG. 10), and arrange the target markers (black dots in FIG. 10) that can be recognized by the radar recognition module in the satellite navigation shadowed area. Setting the target markers in the satellite navigation shadowed area can enable the target markers to be closer to the mower 100, which reduces the shielding of the target marker by other obstacles in the working area, and enables the mower 100 to accurately identify the target markers. Of course, the target markers may also be set in the area enclosed by a boundary of the marker matching area and a boundary of the satellite navigation shadowed area.

It should be noted that, in this embodiment, in order to accurately identify the target markers, the target markers needs to have specific marker feature information that is different from other target markers in the marker matching area. The marker feature information of all target markers may be classified and stored in advance according to the marker matching area to which they belong. Therefore, the corresponding target marker can be accurately identified based on the specific marker feature information, which avoids misjudgment caused by other marker feature information in the working area and improves the positioning accuracy. For example, the target marker may be, for example, a combination of three markers arranged in the triangle, and the specific marker feature information that distinguishes the target markers from other target markers is formed by controlling a distance between the three markers.

When the satellite navigation shadowed area is marked in the working area, the mower 100 can be controlled to walk around the satellite navigation shadowed area in the working area to collect and save the position information of the satellite navigation shadowed area and mark it on the working area map, thereby dividing the working area into the open area and the satellite navigation shadowed area. The open area refers to the area with reliable satellite signals where the mower 100 can accurately position itself based on the satellite navigation signals.

Please refer to FIG. 11. In a specific embodiment of the disclosure, the marker matching area is a rectangular marker matching area. Rectangular marker matching areas A and B are shown in FIG. 11. Taking the rectangular marker matching area B as an example, points a, b, c, and d are the four vertices of the rectangular marker matching area B. Points a, b, c, and d are all in areas with reliable satellite signals. The satellite navigation shadowed area is located in a middle of the rectangular marker matching area B. The mower 100 may sense whether itself has entered the rectangular marker matching area B by determining whether coordinates of the mower 100 are within a range of abcd. In other embodiments, the marker matching area may also be a circular marker matching area. Since the position of the satellite navigation shadowed area will change slightly based on a position of a satellite, in order to avoid affecting the positioning, the satellite navigation shadowed area is located in the marker matching area.

It should be noted that, FIG. 11 shows a condition where the working area includes two satellite navigation shadowed areas and two marker matching areas. However, in actual applications, if there are more satellite navigation shadowed areas and marker matching areas in the working area, there are also more target markers.

Then, execute S220: positioning the mower based on the satellite navigation signal and the working area map in an area with reliable satellite signals outside the satellite navigation shadowed area.

In the open area of the working area, the mower 100 utilizes the positioning module 103 to use kinematic differential positioning technology based on the received satellite navigation signal to control the mower 100 to move along the planned path.

In the open area with reliable satellite signals, the mower 100 may identify the target markers through the radar recognition module according to the marker feature information of the target markers, and obtain the positions and the distance data of the target markers relative to the mower 100. Since the position information of the mower 100 is known, the position information of the target marker may be calculated based on the positions and the distance data of the target markers relative to the mower 100, as well as the position information of the mower 100. It should be noted that, the position information of the target marker may be obtained each time the mowing operation is performed, or may be obtained during the first mowing operation and stored in the storage module 102 for subsequent use.

Execute S230: in the satellite navigation shadowed area, identifying and positioning the target markers in the marker matching area through the identification scanning module 101.

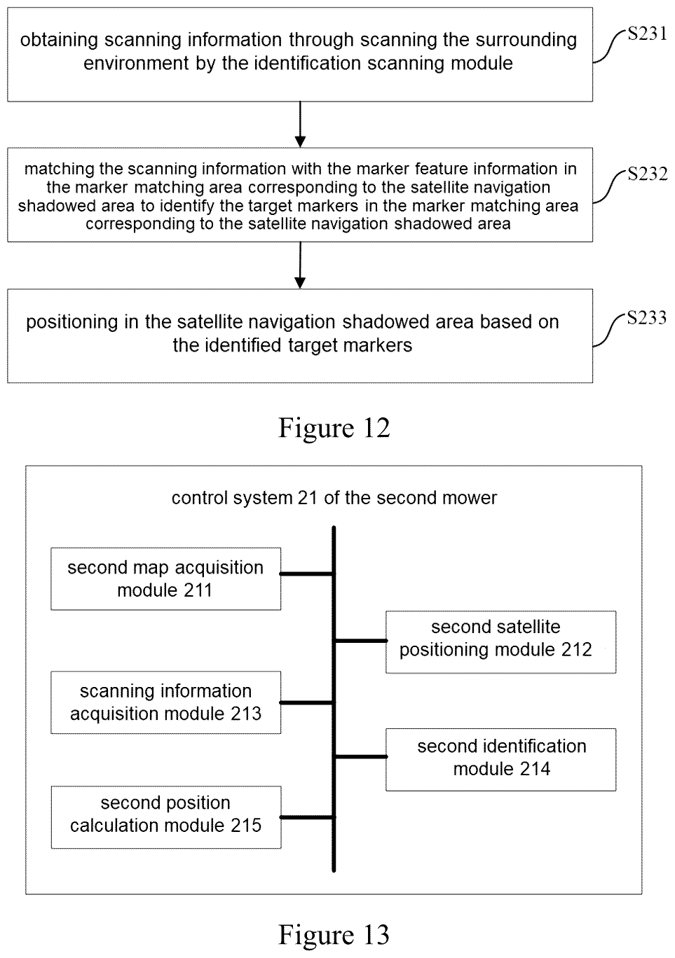

Please refer to FIG. 12. In a specific embodiment, the mower moves to the satellite navigation shadowed area. In the satellite navigation shadowed area, when the target markers in the marker matching area are identified by the identification scanning module 101 for positioning, first, a surrounding environment of the mower is scanned by the identification scanning module 101 to obtain scanning information (S231). Then, the scanning information is matched with the marker feature information in the marker matching area corresponding to the satellite navigation shadowed area to identify the target markers in the marker matching area corresponding to the satellite navigation shadowed area (S232). Finally, the mower is positioned in the satellite navigation shadowed area based on the identified target markers (S233).

In an embodiment, when positioning the mower in the satellite navigation shadowed area based on the identified target markers, a second position and distance data of the identified target markers relative to the mower may be obtained and identified through the identification scanning module 101. The position of the mower in the satellite navigation shadowed area is estimated based on the second position and the second distance data of the identified target markers relative to the mower and the position information of the target markers, so as to position the mower in the satellite navigation shadowed area.

Please refer to FIG. 11. During the operation of the mower 100, the mower 100 may calculate through the satellite navigation signal that the mower 100 has entered the rectangular marker matching area A. When the mower 100 continues to move and enters the satellite navigation shadowed area in the rectangular marker matching area A, the mower 100 cannot obtain its own position through the satellite navigation signal due to a loss of the satellite navigation signal. At this time, the target markers may be collected by the radar recognition module (or other identification scanning modules such as the visual recognition module), and there is no need to match the markers (all the markers in the rectangular marker matching areas A and B in FIG. 11) in an entire map. Only the target markers in the rectangular marker matching area A need to be matched, which reduces an amount of calculation and improves the positioning efficiency. The more markers there are in the working area map, the more obvious the effect is.

After the target markers in the rectangular marker matching area A are identified by the radar recognition module, the second position and the second distance data of the target markers relative to the mower 100 may be obtained, so that the position of the mower 100 in the satellite navigation shadowed area can be estimated based on the second position and the second distance data of the target markers relative to the mower 100 and the position information of the target markers, so as to position the mower 100 in the satellite navigation shadowed area.

In another specific embodiment, after the mower enters the marker matching area, the mower enters a ready state, calls the stored information, obtains the position information of the target markers in the marker matching area, and compares the position information with its current position, thereby obtaining relative positions of the target markers in the marker matching area. When the mower moves further and enters the satellite navigation shadowed area, predicted positions of the target markers are obtained based on the relative position of the target marker, a moving direction and a speed of the garden tool, so as to track and identify the target markers, and perform the positioning based on the target markers.

Please refer to FIG. 11. After the mower enters the rectangular marker matching area A, the mower enters the ready state, calls the stored information, obtains the position information of the target markers in the rectangular marker matching area A, and compares the position information with its current position, thereby obtaining relative positions of the target markers. When the mower 100 moves further and enters the satellite navigation shadowed area, the predicted position of the target markers may be obtained based on the relative position of the determined target markers, the moving direction and the speed of the mower, and a preset range on two sides of the predicted position may be scanned by the identification scanning module to obtain scanning information. The scanning information is matched with the marker feature information in the marker matching area to identify the target markers in the satellite navigation shadowed area. Based on the identified target markers, the mower is navigated and positioned in the satellite navigation shadowed area, thereby avoiding the mower from scanning the target markers over a large range, which reduces a scanning time, and further improves the positioning efficiency and the positioning accuracy of the mower 100.

The satellite navigation shadowed area and the marker matching area are marked in the working area map of the mower 100, and the marker matching area is set around the periphery of the satellite navigation shadowed area. In the area with reliable satellite signals outside the satellite navigation shadowed area, the mower 100 is positioned based on the satellite navigation signal and the working area map. In the satellite navigation shadowed area, the target markers in the marker matching area are identified by the identification scanning module 101 for positioning. By setting the marker matching area, a matching area when identifying the target marker can be narrowed, the amount of calculation can be reduced, and the positioning accuracy and the efficiency can be improved.

FIG. 13 is a functional module of a control system of a second mower according to an embodiment of the disclosure. Please refer to FIG. 13. The control system 21 of the second mower includes a second map acquisition module 211, a second satellite positioning module 212 and a second shadowed area positioning module.

The second map acquisition module 211 is used to obtain the working area map of the mower. The satellite navigation shadowed area is marked in the working area map, and the target markers identified by an identification scanning module are arranged in the satellite navigation shadowed area. In an embodiment, the working area map is further marked with the marker matching area, and each of the marker matching area is arranged around the periphery of the satellite navigation shadowed area.

The second satellite positioning module 212 is configured to position the mower based on the satellite navigation signal and the working area map in the area with reliable satellite signals outside the satellite navigation shadowed area.

The second shadowed area positioning module is configured to position the garden tool through identifying the target markers in the marker matching area through the identification scanning module 101 in the satellite navigation shadowed area. In an embodiment, the second shadowed area positioning module includes a scanning information acquisition module 213, a second identification module 214 and a second position calculation module 215. The scanning information acquisition module 213 is used to scan the surrounding environment of the mower by the identification scanning module 101 to obtain scanning information. The second identification module 214 is used to match the scanning information with the marker feature information in the marker matching area corresponding to the satellite navigation shadowed area to identify the target markers in the marker matching area corresponding to the satellite navigation shadowed area. The second position calculation module 215 is used to position the mower in the satellite navigation shadowed area based on the identified target markers.

It should be noted that, the control system 21 of the second mower of this embodiment is the system corresponding to the above control method of the mower, and the functional modules in the control system 21 of the second mower correspond to the corresponding operations in the control method of the mower respectively. The control system 21 of the second mower of this embodiment may be implemented in cooperation with the control method of the mower. Correspondingly, relevant technical details mentioned in the control system 21 of the second mower in this embodiment may also be applied to the above control method of the mower.

After the working area of the mower is confirmed, a user may still need to have some activities in the working area, such as having a picnic, playing football, etc. In order to prevent the mower from entering an active area during operation and thus causing a safety accident, the user needs to set a temporary restricted area in the determined working area map, and the mower mows based on the working area map with the temporary restricted area set. Since the working area of the mower is relatively large, it is difficult for the user to determine his or her exact position in the working area map, and thus it is difficult to accurately circle the position where the restricted area needs to be set in the working area map.

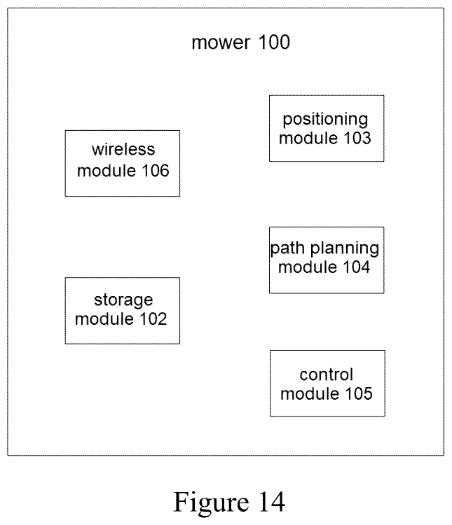

Therefore, please refer to FIG. 14. The mower 100 includes a wireless module 106, the storage module 102, the positioning module 103, the path planning module 104 and the control module 105.

Wherein, the wireless module 106 may be communicated with the mobile terminal, or communicated with the mobile terminal through a background. The mobile terminal may display the working area map, and the user may set the temporary restricted area on the working area map through a user interface of the mobile terminal, and the mower 100 may receive the working area map with the temporary restricted area set from the mobile terminal through the wireless module 106. The storage module 102, the positioning module 103, the path planning module 104 and the control module 105 are described above in detail and will not be described again here.

The mobile terminal may be a portable mobile client terminal such as a mobile phone or a tablet computer. An application program for the user to control the mower 100 is installed on the mobile terminal, and the temporary restricted area may be set in the application program. The mobile terminal displays the working area map of the mower, operating buttons, a graphic selection option/button for selecting a graphic from a pre-made graphic library as a restricted area graphic, and a graphic drawing option/button for the user to manually draw a graphic. The user may remotely control the mower 100 to move by operating buttons to move to a desired position in the working area, such as a target position in the working area where the user needs to set the temporary restricted area. The user may click the graphic selection option/button to display various pre-set graphics in the pre-made graphic library on the mobile terminal, and manually select one or more graphics from them as input graphics as the temporary restricted areas. The user may select the graphic drawing option/button to draw the required graphics with a brush as the temporary restricted areas. In addition, after the user selects a graphic from a pre-made graphic library or manually draws the desired temporary restricted area, the system may further receive a user's parameter adjustment for the temporary restricted area to update the temporary restricted area on the working area map.

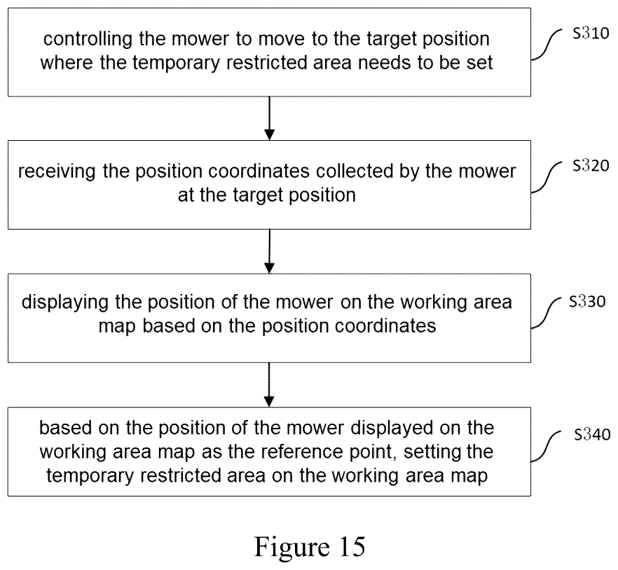

FIG. 15 is a schematic flowchart of a method for setting the temporary restricted area in the working area map. Please refer to FIG. 15. A setting method of the temporary restricted area in the working area map includes operations as follows.

S310: the mower is controlled to move to the target position where the temporary restricted area needs to be set.

S320: position coordinates collected by the mower at the target position are received.

S330: the position of the mower 100 is displayed on the working area map based on the position coordinates.

S340: based on the position of the mower 100 displayed on the working area map as a reference point, the temporary restricted area is set on the working area map.

After the working area of the mower 100 is confirmed, the user may still need to have some activities in the working area, such as having a picnic, playing football, etc. In order to prevent the mower from entering an active area during operation and thus causing a safety accident, the user may set the temporary restricted area in the determined working area map through the mobile terminal associated with the mower 100, and then send the working area map with the temporary restricted area to the mower 100. The mower 100 mows based on the working area map with the temporary restricted area.

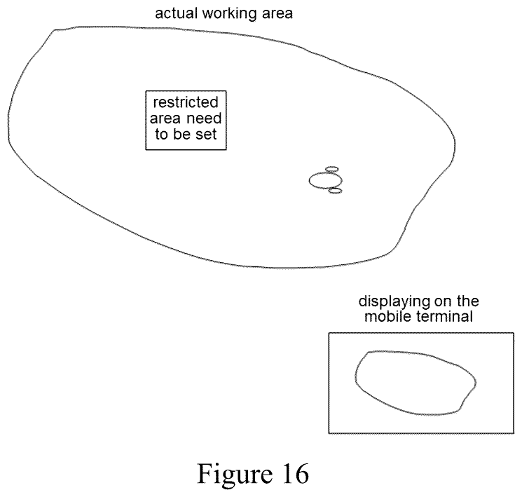

Please refer to FIG. 16. Since the actual working area of the mower 100 is usually relatively large, while the working area map displayed on the mobile terminal is relatively small, and positioning accuracy of the mobile terminal is relatively poor, such as that the positioning accuracy is usually around 2 to 20 meters, it is difficult for the user to accurately determine the position where the temporary restricted area needs to be set in the working area map based on own positioning technology of the mobile terminal or manually.

Considering that the positioning accuracy of the mower 100 using satellite navigation signals for positioning is relatively high, the satellite navigation signals of the mower 100 may be used to assist in obtaining the target position of the temporary restricted area in the working area map. In other words, in the operation of receiving the position coordinates collected by the mower 100 at the target position, the mower 100 may be positioned based on the satellite navigation signal to obtain the position coordinates of the mower 100 at the target position, and send the collected position coordinates to the mobile terminal. For example, the satellite navigation signal may be, for example, a real-time kinematic differential positioning signal (RTK differential positioning signal), and positioning accuracy of a real-time kinematic differential positioning signal is usually 2 to 5 centimeters.

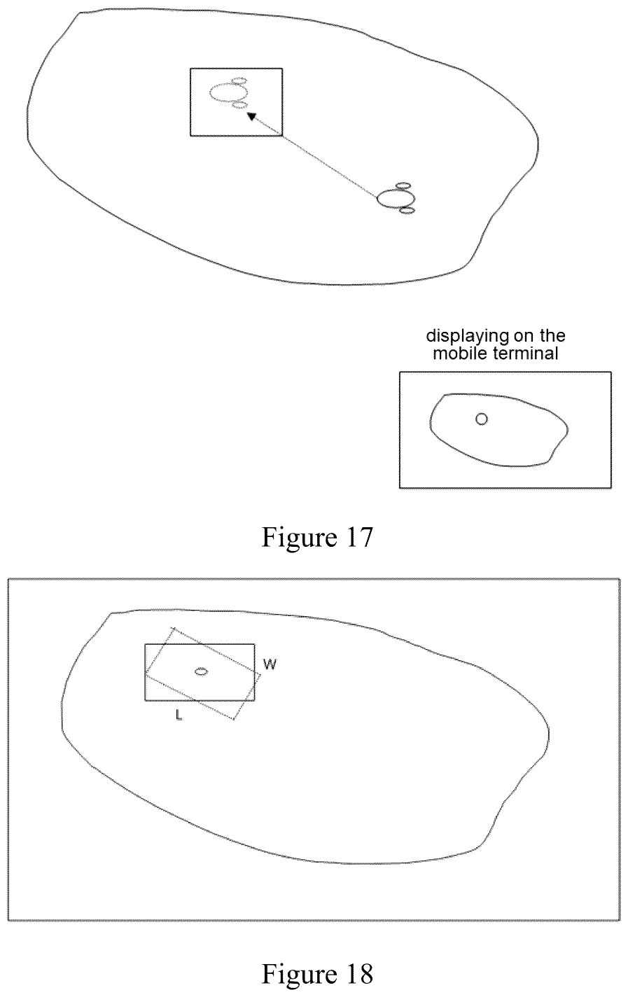

In an embodiment, please refer to FIG. 17. The mower 100 may be remotely controlled to move in the working area through the operating buttons of the mobile terminal, so as to move to the target position in the working area where the temporary restricted area needs to be set. The mower 100 may be positioned based on the RTK differential positioning signal to obtain the position coordinates of the mower 100 at the target position, and send the collected position coordinates to the mobile terminal. The mobile terminal receives the accurate position coordinates at the target position of the mower 100 obtained through the RTK differential positioning technology, so as to display the current position of the mower 100 on the working area map of the mobile terminal according to the position coordinates. The current position is also the target position on the working area map where the temporary restricted area needs to be set. Subsequently, the temporary restricted area may be set on the working area map based on the position displayed by the mower 100 on the working area map as the reference point.

Please refer to FIG. 18 through FIG. 20. When setting the temporary restricted area on the working area map based on the position of the mower 100 displayed on the working area map as the reference point, the restricted area shape input by the user may be first received. Then, based on the position of the mower 100 displayed on the working area map as the reference point, a shape corresponding to a restricted area shape is set on the working area map as the temporary restricted area. After setting the temporary restricted area, the user's parameter adjustment for the temporary restricted area may further be received to update the temporary restricted area on the working area map.

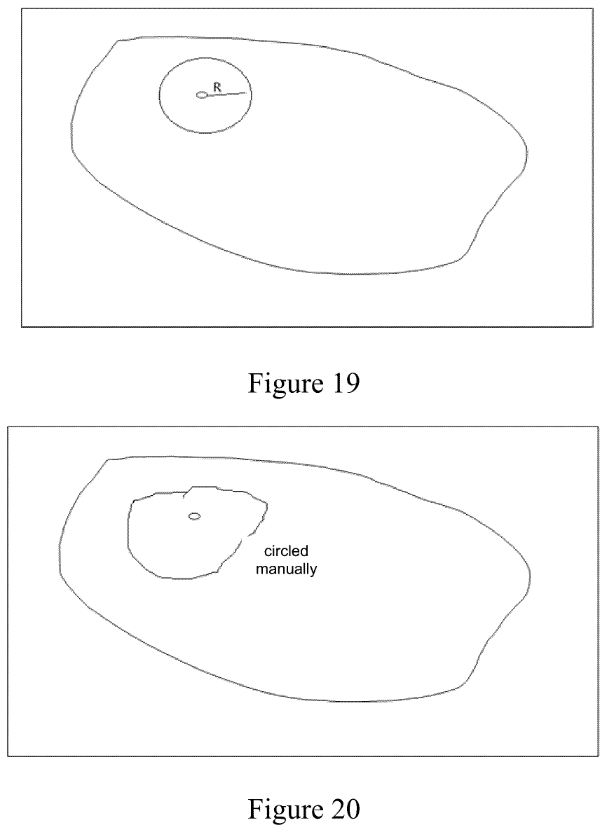

It should be noted that, receiving the restricted area shape input by the user may include two methods. One method is to receive the graphic selected by the user from the pre-made graphic library as shown in FIG. 18 and FIG. 19 as the restricted area shape input by the user. The other method is to receive the graphic manually drawn by the user as shown in FIG. 20 as the restricted area shape input by the user. The following will describe in detail three specific embodiments of setting the temporary restricted area on the working area map based on the position of the mower 100 displayed on the working area map as the reference point.

Please refer to FIG. 18. After determining the target position of the temporary restricted area on the working area map, the user may click the graphic selection option/button in a display interface in the mobile application program to display various graphics pre-set in the mobile terminal pre-made graphic library, and manually select a rectangle from them. After selecting the rectangle, parameters such as a length (L), width (W) and direction of the rectangle may be adjusted to generate a rectangular temporary restricted area, and a center point of the rectangular temporary restricted area coincides with the determined target position of the temporary restricted area. It should be noted that, length and width parameter data of the rectangle may be adjusted by manually inputting specific values or manually scaling, and direction parameter data of the rectangle may be adjusted by inputting a specific rotation angle or manually rotating the rectangle around the center point.

Please refer to FIG. 19. After determining the target position of the temporary restricted area on the working area map, the user may click the graphic selection option/button in the display interface in the mobile application program to display various graphics pre-set in the mobile terminal pre-made graphic library, and manually select a circle from them. After selecting the circle, a radius of the circle may be adjusted to generate a circular temporary restricted area of a desired size, and a center of the circular temporary restricted area coincides with the target position of the determined temporary restricted area. It should be noted that, the radius of the circle may be adjusted by manually entering a specific value or manually scaling.

It should be noted that, in this embodiment, the preset graphics may be other shapes besides rectangle and circle, such as triangle, ellipse, pentagon, etc.

Please refer to FIG. 20. After determining the target position of the temporary restricted area on the working area map, the user may click the graphic drawing option/button in the display interface in the mobile application program to call out a graphic drawing window. The user may manually circle an area using the target position of the temporary restricted area as the reference point to serve as the temporary restricted area.

After the temporary restricted area is set on the working area map through the mobile terminal, the mower 100 will be controlled to leave the temporary restricted area, and the working area map with the temporary restricted area set will be sent to the mower 100. The mower 100 receives the working area map with the temporary restricted area sent by the mobile terminal. Based on the working area map with the temporary restricted area, the mower 100 is controlled to move and operate in the working area to avoid an area corresponding to the temporary restricted area.

In an embodiment, after the mower 100 receives the working area map with the temporary restricted area through the wireless module 106, the working area map with the temporary restricted area will be stored in the storage module 102. The path planning module 104 plans a working path of the mower 100 in the working area according to the working area map with the temporary restricted area to exclude the temporary restricted area from the path planning. After the path planning is completed, the control module 105 may control a movement of the walking component of the mower 100 based on the navigation positioning information of the positioning module 103 to operate according to the planned path, thereby avoiding the temporary restricted area.

It should be noted that, the method for setting the temporary restricted area on the working area map of the embodiment further includes setting a restricted area effective time for the temporary restricted area, monitoring a duration time of the temporary restricted area, and when the duration time of the temporary restricted area exceeds the restricted area effective time, clearing the temporary restricted area in the working area map and sending the working area map after clearing the temporary restricted area to the mower 100, so that the mower 100 can re-plan a path based on the working area map after clearing the temporary restricted area, and operate according to the re-planned path.

The restricted area effective time may be flexibly set according to actual needs, such as 1 hour, 4 hours, 12 hours, 1 day, 2 days, . . . and so on. Further, after the temporary restricted area is set, a verification program may be set, and the mower 100 will walk along a boundary of the temporary restricted area that has been set. If a walking path is consistent with the preset temporary restricted area, the user confirms that it is correct, and the map of the temporary restricted area is stored in the storage module 102 of the mower 100. If the walking path is not consistent with the preset temporary restricted area, the user will reset it. When the mower 100 travels along the boundary of the temporary restricted area, cutting blades of the mower do not work.

The method for setting the temporary restricted area on the working area map of this embodiment controls the mower 100 to move to the target position where the temporary restricted area needs to be set, receives the position coordinates collected by the mower 100 at the target position, displays the position of the mower 100 on the working area map according to the position coordinates, and sets the temporary restricted area on the working area map based on the position of the mower 100 displayed on the working area map as the reference point. Based on accurate positioning characteristics of the mower 100, the reference point where the temporary restricted areas need to be set are directly specified in the actual working area, so that the temporary restricted area may be set quickly and accurately on the mobile terminal, thereby improving efficiency and accuracy of setting the temporary restricted area.

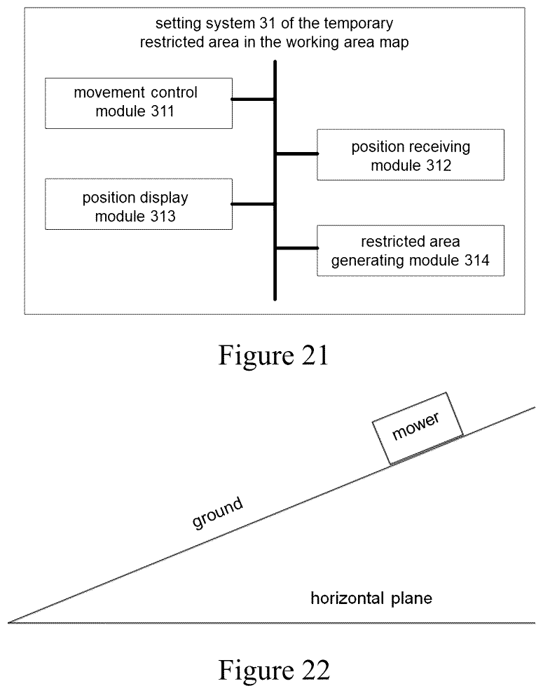

FIG. 21 is a functional module view of a setting system of the temporary restricted area in the working area map of the embodiment of the disclosure. Please refer to FIG. 21. The setting system 31 of the temporary restricted area of the working area map includes a movement control module 311, a position receiving module 312, a position display module 313 and a restricted area generating module 314.

The movement control module 311 is used to control the mower to move to the target position where the temporary restricted area needs to be set.

The position receiving module 312 is used to receive the position coordinates collected by the mower at the target position.

The position display module 313 is used to display the position of the mower 100 on the working area map based on the position coordinates.

The restricted area generating module 314 is used to set the temporary restricted area on the working area map based on the position of the mower 100 displayed on the working area map as the reference point.

It should be noted that, the setting system 31 of the temporary restricted area of the working area map of this embodiment is a system corresponding to the above-mentioned setting method of the temporary restricted area of the working area map, and the functional modules in the setting system 31 of the temporary restricted area of the working area map correspond to the corresponding operations in the setting method of the temporary restricted area of the working area map respectively. The setting system 31 of the temporary restricted area of the working area map of this embodiment may be implemented in coordination with the setting method of the temporary restricted area of the working area map. Correspondingly, relevant technical details mentioned in the setting system 31 of the temporary restricted area of the working area map of this embodiment may also be applied to the setting method of the temporary restricted area of the working area map.

The mower may be lifted up manually during operation. In this case, running cutter assembly may cause harm to the human body. Therefore, the mower is generally provided with a lifting sensor. When the mower is lifted up manually, the lifting sensor detects that the mower leaves the ground and triggers a shutdown instruction to ensure a safety of personnel. However, in an actual application condition, the lifting sensor may fail. At this time, an automatic stop function cannot be triggered after the mower is lifted. Therefore, a safety protection measure is needed to ensure that the mower can be stopped in time after being lifted.

Since the RTK differential positioning method has high positioning accuracy and can obtain displacements in X, Y, and Z directions, it has high recognition sensitivity for short-stroke movements such as lifting garden tools. Therefore, based on the RTK differential positioning technology, an embodiment of the disclosure provides the mower, and the mower can determine whether a body of the mower is lifted manually through RTK positioning information.

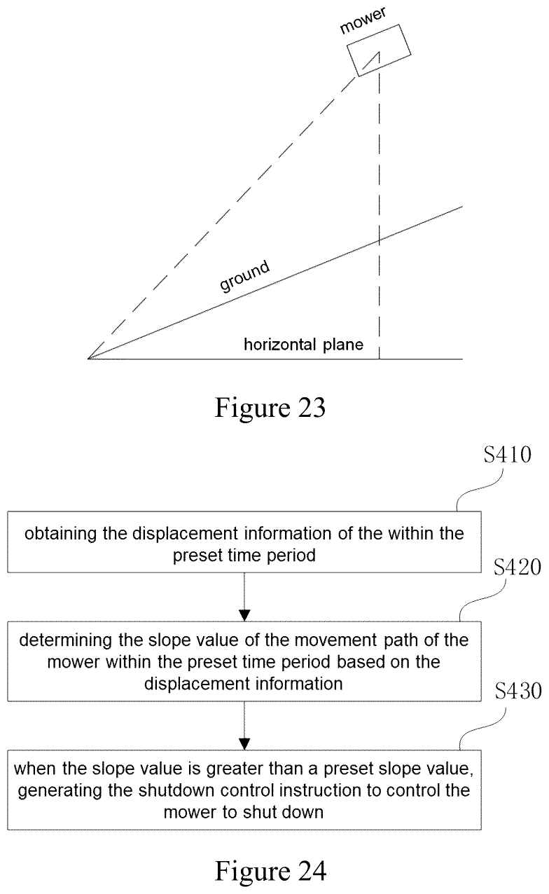

First, a principle of a ground-lift detection is explained. The mower mainly travels on flat ground. Therefore, generally, as long as a distance from the ground is detected to be greater than a certain threshold, it may be determined that a lifting action has occurred. For example, when a vertical displacement of the mower within a preset time period is greater than the certain threshold, it may be determined that the mower has been lifted. Further, please refer to FIG. 22. The mower may travel on a slope when it is in a normal working state. However, it may be understood that, the slope that the mower can adapt to is obviously limited. Please refer to FIG. 23. When it is detected that the slope of a movement path of the mower is greater than a maximum slope that the mower can adapt to, it proves that the mower obviously does not rely on its own power to complete this displacement. Then at this time, a biggest possibility at this time is that the mower is lifted up artificially. Based on this, in order to eliminate an interference of the mower working on the slope, the disclosure further provides a method for verifying the slope.

Please refer to FIG. 24. A ground-lift detection method includes operations as follows.

S410: displacement information of the mower is obtained within a preset time period.

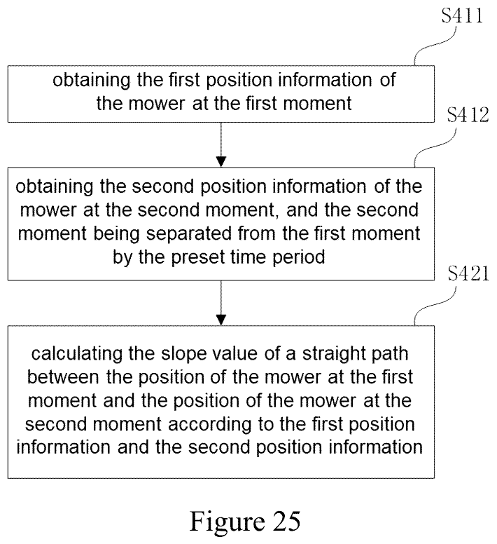

Please refer to FIG. 25. In a specific embodiment, the displacement information of the mower is obtained by the following method.

S411: first position information of the mower is obtained at a first moment.

S412: second position information of the mower is obtained at a second moment, and the second moment is separated from the first moment by the preset time period.

In a specific embodiment, the first position information is the RTK positioning information of the mower at the first moment, and the second position information is the RTK positioning information of the mower at the second moment. Since the RTK positioning information has a high positioning accuracy and the mower will have a movement range of at least 50 cm when being lifted manually, the RTK positioning information can accurately identify this position change.

It may be understood that, in addition to using RTK positioning information for identification, the above displacement information may also be achieved by other high-accuracy positioning methods, such as using an acceleration and angular velocity information collected by the IMU module to predict the displacement and direction of the mower, or integrating the acceleration and angular velocity information of the IMU module with the RTK differential positioning information to further improve a recognition accuracy of the displacement information.

S420: the distance of the mower from the ground within the preset time period is determined based on the displacement information. In a specific embodiment, the distance from the ground may be verified, for example, by the vertical displacement or by a slope value of the movement path.

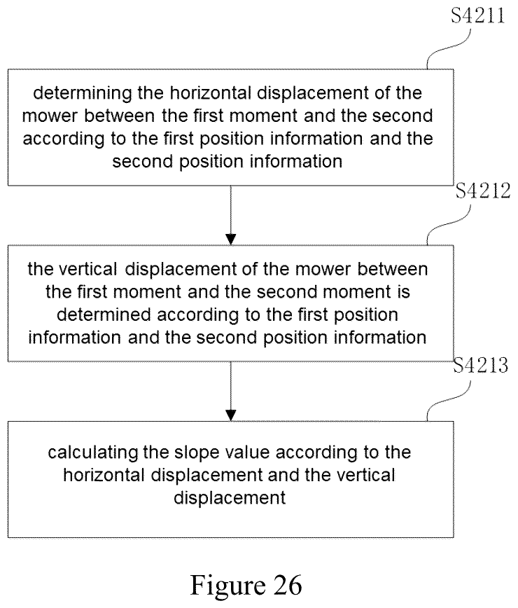

Please refer to FIG. 25 and FIG. 26. In a specific embodiment, the slope value is obtained by the following method.

S421: the slope value of a straight path between the position of the mower at the first moment and the position of the mower at the second moment is calculated according to the first position information and the second position information.

Further, S421 specifically includes operations as follows.

S4211: a horizontal displacement of the mower between the first moment and the second moment is determined according to the first position information and the second position information.

S4212: the vertical displacement of the mower between the first moment and the second moment is determined according to the first position information and the second position information.

S4213: the slope value is calculated according to the horizontal displacement and the vertical displacement.

It may be understood that, the horizontal displacement of the mower includes both a displacement in an X direction and a displacement in a Y direction. When calculating, a trigonometric function should be used to combine the displacement in the X direction and the displacement in the Y direction into the total horizontal displacement before participating in a slope calculation.

S430: when the slope value is greater than a preset slope value, a shutdown control instruction is generated to control the mower to shut down.

In a specific embodiment, a specific process of S430 is as follows.

When the horizontal displacement of the mower is less than the preset horizontal displacement, and an upward vertical displacement of the mower is greater than the preset vertical displacement, the shutdown control instruction is generated to control the mower to shut down.

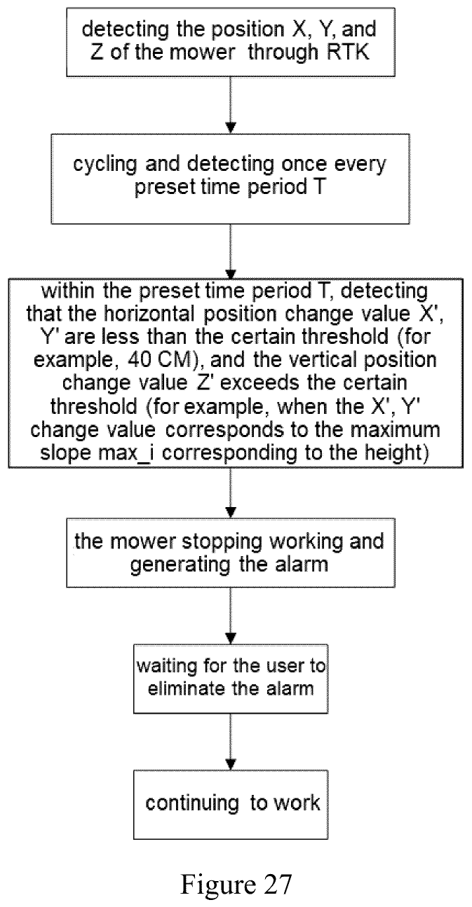

Please refer to FIG. 27. The following is a detailed description of an embodiment of the disclosure in conjunction with a specific working process.

During the normal operation of the mower, the RTK positioning information is detected once every preset time period T to obtain X, Y, and Z coordinates of the mower. When a horizontal position change X′, Y′ of two adjacent detections is less than a certain threshold (for example, the total displacement in the X and Y directions is less than 40 cm), and an increase in a vertical position change Z′ is greater than a certain threshold (for example, the vertical position change is greater than a height corresponding to a maximum slope max_i that the mower corresponding to the horizontal position change X′, Y′ can adapt to), the control module generates a shutdown instruction, controls the mower to stop working, and generates an alarm. After waiting for the user to eliminate the alarm, and the mower continues to work.

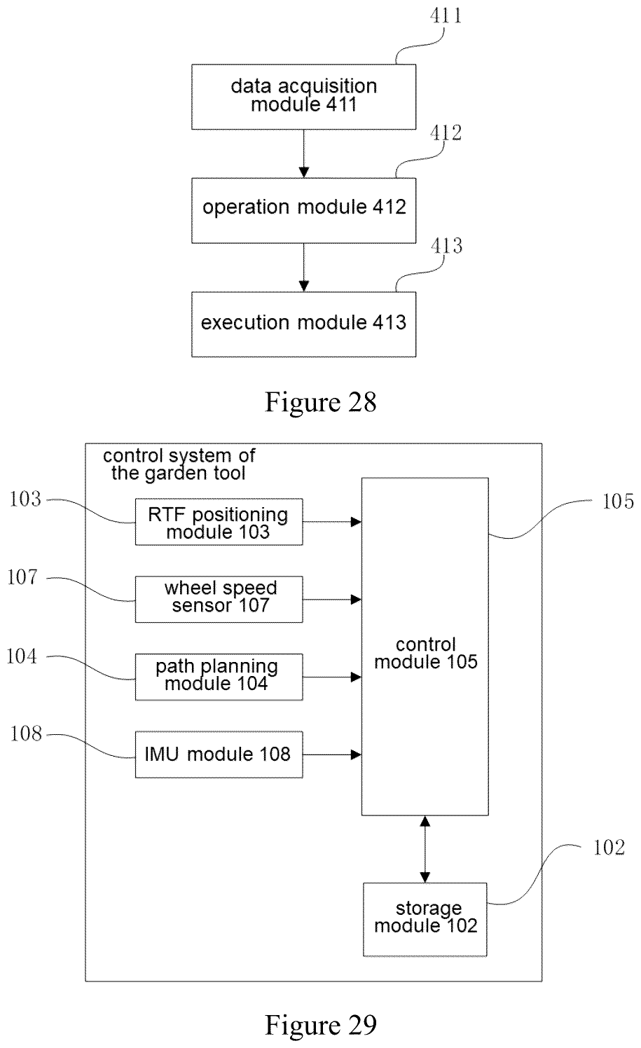

Please refer to FIG. 28. The disclosure provides a mower ground-lift detection device. The mower ground-lift detection device includes a data acquisition module 411, an operation module 412 and an execution module 413. The data acquisition module 411 is used to obtain the displacement information of the mower within the preset time period. The operation module 412 is used to determine the slope value of the movement path of the mower within the preset time period according to the displacement information. The execution module 413 is used to generate the shutdown control instruction to control the mower to shut down when the slope value is greater than the preset slope value.

It should be noted that, the mower ground-lift detection device of this embodiment is the device corresponding to the above ground-lift detection method of the mower, and the functional modules in the mower ground-lift detection device correspond to the corresponding operations in the ground-lift detection method of the mower respectively. The mower ground-lift detection device of this embodiment may be implemented in cooperation with the ground-lift detection method of the mower. Correspondingly, relevant technical details mentioned in the mower ground-lift detection device of this embodiment may also be applied to the above ground-lift detection method of the mower.

Please refer to FIG. 29. The disclosure further provides the control system of the mower realizing the ground-lift detection of the mower, which includes the RTF positioning module 103, the control system 105, a wheel speed sensor 107, the path planning module 104, an IMU module 108 and the storage module 102. The positioning module 103 is used to send the RTK positioning information of the mower. The control module 105 is communicated with the RTK positioning module 103, and is used to receive the RTK positioning information and calculate a displacement trajectory of the mower per unit time. When a slope value of the displacement trajectory is greater than the preset value, the control module controls the mower to shut down. The wheel speed sensor 107 is used to detect a wheel rotating speed of the mower. The path planning module 104 is used to plan the walking path according to a garden function. The IMU module 108 is used to detect a state of the mower and calculate the position of the mower. The storage module 102 is used to store map data of the working area of the mower. The wheel speed sensor 107, the path planning module 104, the IMU module 108, and the storage module 102 are respectively connected with the control module 105 for communication.

In summary, the disclosure can use the displacement information of the mower to determine whether the mower is lifted. When a lifting sensor of the mower fails, the disclosure can perform a secondary detection of a lifting state of the mower to ensure that the mower can be stopped in time after being lifted, thereby ensuring a safety of the user.

Due to constraints of battery energy density, battery production cost and other factors, power of the battery pack carried by the mower is very limited, resulting in a small operating area of the mower at one time. When a lawn area is large, the mower needs to return to a charging station for charging after working for a certain period of time. After charging is completed, it leaves the charging station and returns to the working area to mow.

When the mower returns to the charging station for charging after working for the certain period of time, most mowers move to a front of the charging station and enter the charging station, which causes a road section in front of the charging station to be repeatedly rolled over, and easily creates rutting, thus affecting a growth of lawns or vegetation in a rutting area.

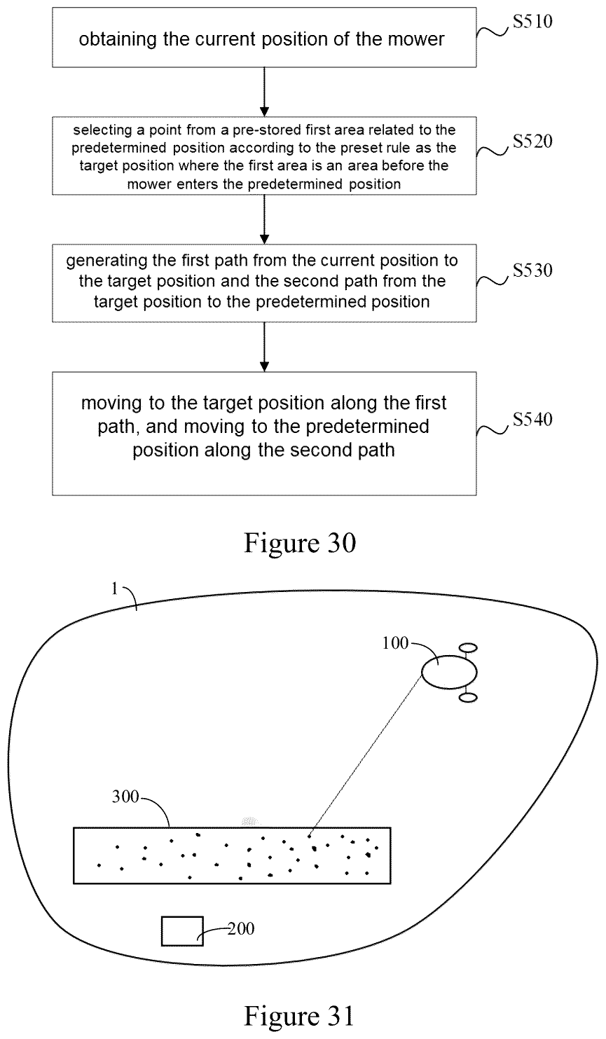

Based on this, please refer to FIG. 30 through FIG. 32. The disclosure provides a method and a system for guiding the mower to a predetermined position and the mower with the system.

In an embodiment, the mower 100 includes a machine body 10, a walking assembly 120 and a regressive walking control system 123. The walking assembly 120 and the regressive walking control system 123 are both installed on the machine body 10. The regressive walking control system 123 is used to control the walking assembly 120 to move to the predetermined position along a planned path when the mower needs to return to the predetermined position. In an embodiment of the disclosure, the predetermined position is the charging station of the mower.

Please refer to FIG. 30 through FIG. 32. In this embodiment, the walking assembly 120 includes driving wheels located on two sides of the machine body. The driving wheels are generally located at a rear of the machine body. The two driving wheels are driven by two driving motors respectively. At least one supporting wheel is further arranged in the front of the machine body. The mower 100 is supported by the driving wheels and the supporting wheel for walking. The supporting wheel may be, for example, universal wheel to facilitate a turning of the mower 100. A first control module 124 controls a walking direction and a walking speed of the mower 100 through controlling rotating speeds of the two driving motors. When the rotating speeds of the driving motors are different, the mower 100 may turn. When the rotating speeds of the driving motors are the same, the mower 100 may walk in a straight line. When the rotating speeds of the driving motors are opposite, the mower 100 may turn in situ.

Please refer to FIG. 30 through FIG. 32. In this embodiment, the mower 100 further includes an operating assembly 109 and a power supply module 110 arranged on the machine body 10. The operating assembly 109 includes a cutting motor and a cutting head driven by the cutting motor. The operating assembly 109 is approximately located at a center of the mower 100. A rotating axis of the cutting motor is approximately perpendicular to a horizontal plane. A height of the operating assembly 109 from the ground may be adjusted by the operator to achieve an adjustment of a cutting height. The power supply module 110 includes a rechargeable battery and a charging system for supplying power to the rechargeable battery.

The first control module 124 receives various signals sent to the mower 100, generates corresponding control signals through a built-in processor, and controls the walking assembly 120 or an operation assembly 109 according to the generated control signals, so that the mower 100 leaves the charging station 200 along the planned path to mow, and the mower 100 may further guide the mower to the predetermined position according to the path planned by the regressive walking control system 123 below, such as returning to the charging station 200 for charging.

Please refer to FIG. 30 through FIG. 33. In this embodiment, the regressive walking control system 123 includes the positioning module 103, a target confirmation module 115, the path planning module 104 and a second control module 116. The positioning module 103 is used to determine the position of the mower. The target confirmation module 115 is used to select a point from a pre-stored first area 300 related to the predetermined position according to a preset rule as the target point. The first area 300 is an area before the mower enters the predetermined position. The path planning module 104 is used to obtain a first path for the mower 100 to move from a current position to the target position, and to obtain a second path for the mower 100 to move from the target position to the predetermined position, such as a position of the charging station 200. The second control module 116 is used to control the walking assembly 120 so that the mower 100 moves to the target position along the first path, and controls the walking assembly 120 so that the mower 100 moves to the predetermined position along the second path for charging.

Each time, the mower 100 selects a point as the target position from the first area 300 according to the preset rule, moves to the target position, and then moves to the predetermined position. Since the mower 100 selects a different target position each time, the path of the mower 100 moving to the predetermined position is also different, thereby avoiding repeated crushing of a lawn and causing indentations. In some embodiments, the first control module 124 of the mower and the second control module 116 of the regressive walking control system 123 may be integrated together.

Please refer to FIG. 30. In this embodiment, the mower 100 may further include an alarm module, which is used to send a battery warning message when the power of the mower 100 is low.

It should be noted that, a boundary of the first area 300 is a virtual boundary, and a guiding point is a virtual point, which can be stored in the second control module 116 of the regressive walking control system 123 in a form of points or coordinates.

Please refer to FIG. 30 through FIG. 33. In this embodiment, the positioning module 103 is the RTK positioning module, which uses the RTK differential information of a wireless receiving base station to achieve an accurate positioning. The RTK positioning module is used to obtain the current position and direction of the mower 100, and output the current position and direction of the mower 100 to the path planning module 104 and the second control module 116, so that the path planning module 104 may plan the first path and the second path according to the selected target position and the position of the charging station 200. At the same time, the second control module 116 may adjust its walking assembly 120 according to the direction and position of the mower 100, so that the mower 100 can be smoothly connected with the charging station 200 for charging.

It should be noted that, the regressive walking control system of the mower of the disclosure is a system corresponding to the following method of guiding the mower to the predetermined position, and the functional modules or functional sub-modules in the regressive walking control system of the mower respectively correspond to the corresponding operations in the method of guiding the mower to the predetermined position.

Please refer to FIG. 30, FIG. 31, FIG. 33 through FIG. 36. The disclosure further provides the method for guiding the mower to the predetermined position. The method for guiding the mower to the predetermined position is applied to the regressive walking control system of the mower described in the above embodiment. The method for guiding the mower to the predetermined position includes operations as follows.

S510: the current position of the mower 100 is obtained.

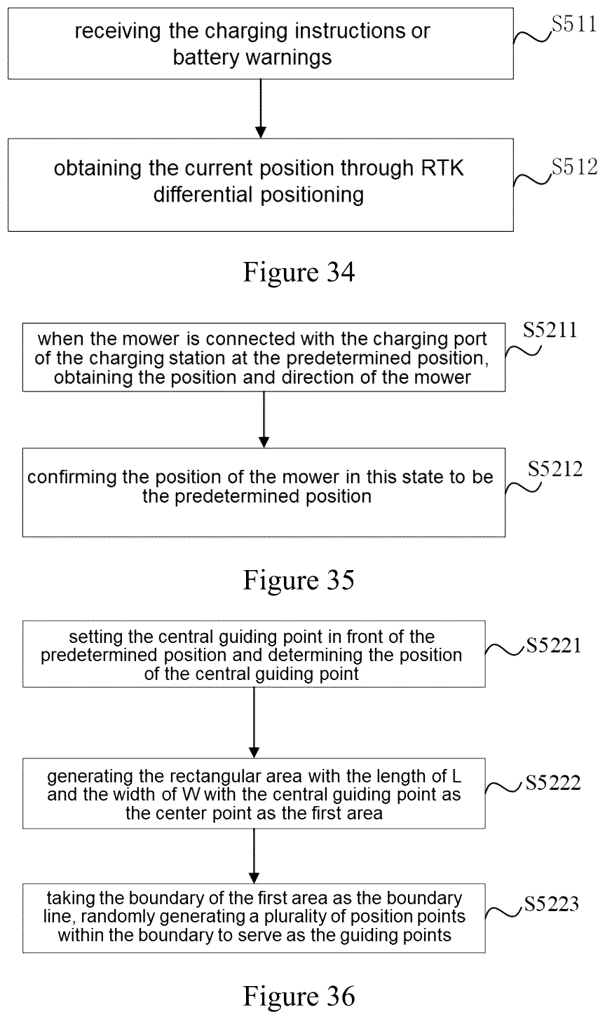

Please refer to FIG. 30 and FIG. 34. In this embodiment, the positioning module 103 is the RTK positioning module. Obtaining the current position of the mower includes operations as follows.

S511: charging instructions or battery warnings are received.

S512: the current position is obtained through RTK differential positioning.

Please refer to FIG. 30 and FIG. 34. For example, the second control module 116 may receive the charging instruction to notify the positioning module 103 to obtain the current position, or the second control module 116 may receive battery warning message issued by the alarm module to notify the positioning module 103 to obtain the current position.

S520: a point is selected from a pre-stored first area 300 related to the predetermined position according to the preset rule as the target position. Wherein the first area 300 is an area before the mower 100 enters the predetermined position, and the predetermined position is, for example, the charging station 200.

It should be noted that, the preset rule is to select any point in the first area 300 as the target position. In other embodiments, the preset rule is to select any point in the first area 300 that is different from last time as the target position.

Please refer to FIG. 30 and FIG. 36. In this embodiment, the first area 300 may be located within the working area 1 of the mower 100, and a shortest distance between a boundary point of the first area 300 and the predetermined position is greater than a minimum turning radius of the mower 100, so as to facilitate the mower to adjust the direction or turn at this position, so that it can be smoothly for the mower to be connected with the predetermined position, for example, it can be smoothly connected with the charging station 200 for charging.

In some embodiments, since the working area 1 of the mower 100 is too large, a plurality of predetermined positions may be set in the working area 1, such as the charging station 200. Therefore, before selecting a point as a target point from the pre-stored first area 300 related to the charging station 200 according to the preset rule, the following operations are further included.

According to a distances between the current position of the mower 100 and the plurality of predetermined positions, the predetermined position closest to the current position is selected. For example, according to the distances between the current position of the mower 100 and the plurality of charging stations 200, a charging station 200 closest to the current position is selected.

Please refer to FIG. 35. In some embodiments, determining positions of the plurality of charging stations 200 corresponding to the mower 100 includes operations as follows.

S5211: when the mower 100 is connected with a charging port of the charging station 200 at the predetermined position, the position and direction of the mower 100 are obtained. Wherein, an accurate position of the mower 100 may be obtained through the RTK positioning module.

S5212: the position of the mower 100 in this state is confirmed to be the predetermined position, which means that the position of the charging station 200.

Please refer to FIG. 36. In this embodiment, determining a position of the first area 300 includes operations as follows.

S5221: a central guiding point is set in front of the predetermined position (charging station 200) and a position of the central guiding point is determined. In this embodiment, the position of the central guiding point or a marking or storage of its position coordinates may be achieved, for example, by the RTK positioning module.

Please refer to FIG. 30. In this embodiment, determining the position of the central guiding point includes operations as follows.

When the mower 100 is connected with the charging port of the charging station 200, the position and direction of the mower 100 are obtained.

In this state, the position along the direction of the mower 100 and spaced a certain distance from the charging station 200 is confirmed as the position of the central guiding point.

S5222: a rectangular area with a length of L and a width of W is generated with the central guiding point as a center point as the first area 300. For example, coordinates of the central guiding point may be used as the center coordinates, coordinates of positions of four vertices of the rectangular area may be determined with the length of L and the width of W, and the four vertices are connected by straight lines as virtual boundaries to form the rectangular first area 300.

S5223: the boundary of the first area 300 is taken as a boundary wire, a plurality of position points are randomly generated within the boundary to serve as guiding points. In some embodiments, the guiding points are virtual points, which is stored in a form of coordinates in the control unit of the mower 100 and/or the second control module 116 of the regressive walking control system 123.

It should be further noted that the guiding points determined in the first area 300 may be numbered, and the first area 300 with the numbered guiding points may be pre-stored in the mower 100. One guiding point is selected from the first area 300 related to the charging station 200 pre-stored in the mower 100 according to the preset rule as the target position. The preset rule may be to select the corresponding guiding point as the target position in an order of the number according to charging times.

S530: a first path from the current position to the target position and a second path from the target position to the predetermined position are generated. For example, the second control module 116 selects any point in the first area 300 as the target position, and transmits data of the target position to the path planning module 104. The path planning module 104 plans the first path according to the current position of the mower 100 and the position of the target position, and then plans the second path according to the position of the target position and the position of the charging station 200.

S540: the mower moves to the target position along the first path, and move to the predetermined position along the second path. For example, the second control module 116 controls the walking assembly 120 of the mower 100 to move to the target position along the first path, and the second control module 116 controls the walking assembly 120 of the mower 100 to move to the position of the charging station 200 along the second path, so as to be connected and charged with the charging station 200.

This embodiment further provides a storage medium with a computer program stored thereon. When the computer program is executed by a processor, operations of a method of guiding the mower to the predetermined position in the embodiment are implemented.

It should be noted that, functions or operations that can be implemented by the computer storage medium or computer device may be referred to in the aforementioned method embodiments. To avoid repetition, they will not be described one by one here.

The method, the system and the mower of the disclosure for guiding the mower to the predetermined position, set the first area in front of the charging station and determine the plurality of guiding points in the first area. The mower randomly selects the guiding point as the target position when returning to charge, moves to the target position, and then moves to the charging pile for charging, thereby avoiding a case that a conventional mower sets a fixed point, and causes a road section between the fixed point and the charging station to be repeatedly rolled over and easily produce rutting marks, thereby avoiding affecting a growth of lawn or vegetation in a rutting area.

For the mower using RTK differential positioning technology for positioning, a base station is installed near the working area of the mower. The base station provides RTK differential information for the mower. The mower corrects GPS positioning information according to the RTK differential information to obtain high-accuracy positioning information. The mower can draw and store the map data according to the walking path. Since the map data is drawn based on RTK differential positioning information, the map data will be associated with the position information of the base station. However, in actual application, the base station often needs to be moved for various reasons. A movement of the base station will cause the map data to become invalid and the mower will not work normally. Therefore, the map data needs to be re-debugged and calibrated according to the new position of the base station.

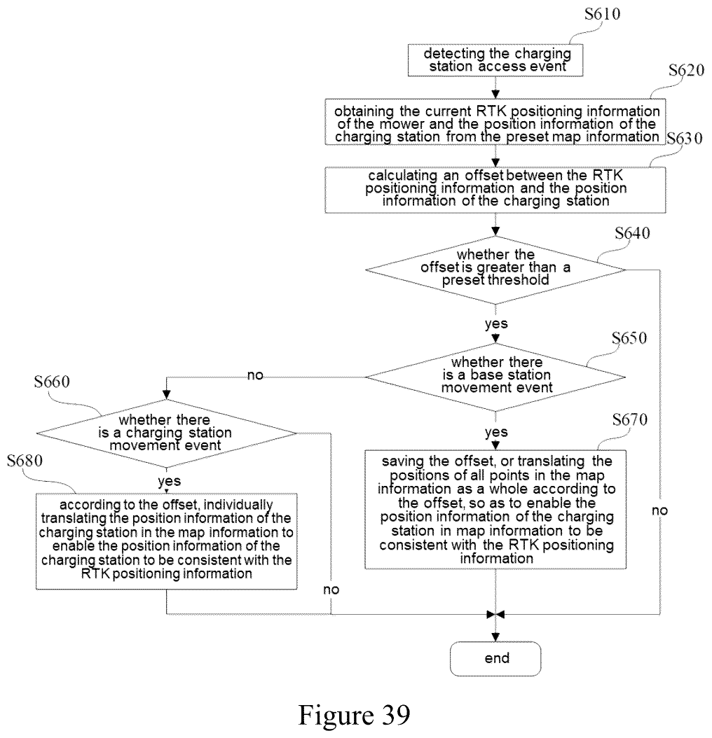

FIG. 14 is a structural block view of the mower 100. FIG. 39 is a schematic flowchart of the calibration method of the navigation information of the mower according to at least one embodiment of the disclosure.

Please refer to FIG. 39. The calibration method of the navigation information of the mower includes operations as follows.

S610: a charging station access event is detected. It should be noted that when the position of the base station changes, the mower cannot find the charging station by autonomous driving, so the user needs to manually move the mower to the charging station, or remotely control the mower to drive to the charging station.

S620: the current RTK positioning information of the mower is obtained and the position information of the charging station is obtained from the preset map information.

S630: an offset between the RTK positioning information and the position information of the charging station is calculated.

S640: whether the offset is greater than a preset threshold is determined.

S650: whether there is a base station movement event is determined.

S660: whether there is a charging station movement event is determined.

S670: when there is the base station movement event, the offset is saved, or the positions of all points in the map information are translated as a whole according to the offset, so that the position information of the charging station in map information is consistent with the RTK positioning information.

S680: when there is the charging station movement event, according to the offset, the position information of the charging station in the map information is individually translated to enable the position information of the charging station to be consistent with the RTK positioning information.

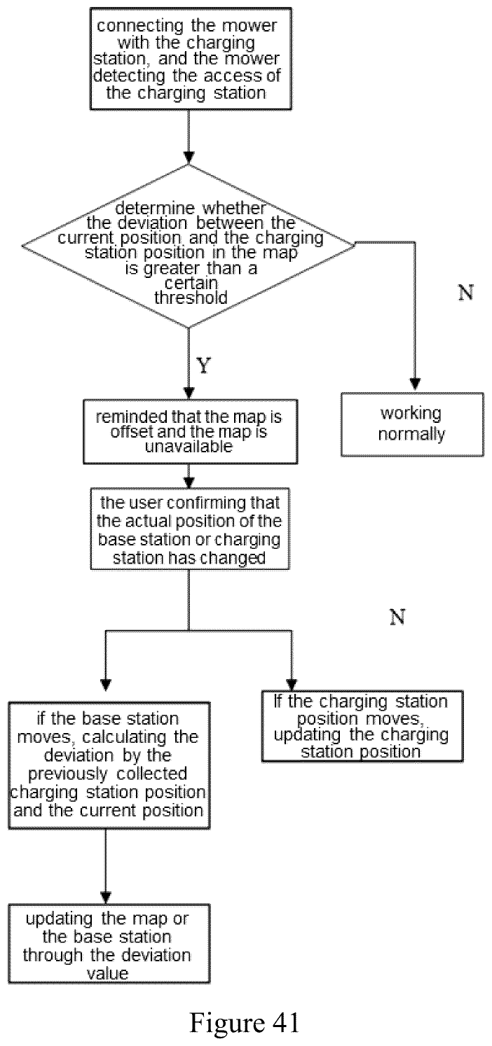

Please refer to FIG. 41. In a specific embodiment, a charging station access event includes accessing a single charging station. When the offset is greater than the preset threshold, a position change prompt message is generated to prompt the user that the current map is unavailable.

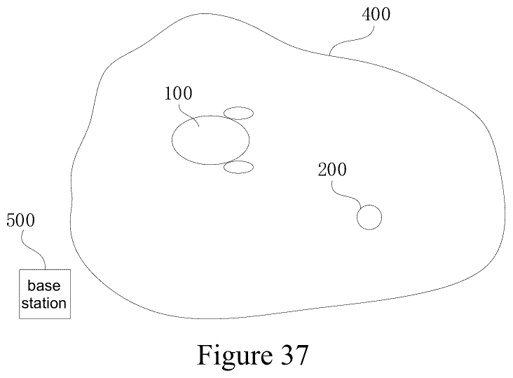

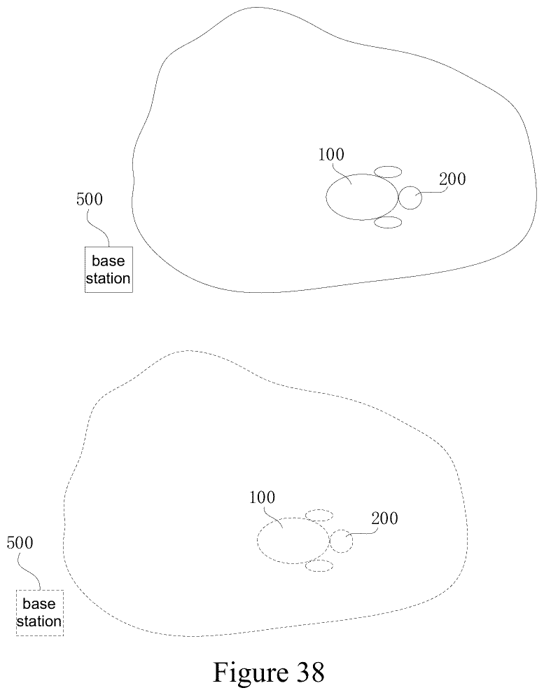

Please refer to FIG. 41. In a specific embodiment, determining whether there is the base station movement event or the charging station movement event includes: receiving input information fed back by the user based on the position change prompt information, when the input information includes base station movement information, determining that there is the base station movement event, or when the input information includes charging station movement information, determining that there is the charging station movement event. It may be understood that, this embodiment is applicable to a case where there is only one charging station in the working area as shown in FIG. 37 and FIG. 38. In this case, the mower cannot determine whether it is a base station offset or a charging station offset based on a relative position relationship of more than two charging stations, so the mower can only be informed through a manual input. In an actual operation, the movement of the charging station or the base station is performed by the user himself, so the user may know whether the charging station or the base station has moved. In addition, even if the charging station or base station is displaced due to other people or animals, when the mower cannot enter the charging station according to the pre-set path, the user may know that a movement event of the charging station or base station has occurred. At this time, the user may check the charging station or base station and then determine the position of the charging station or base station to achieve a reposition of the map information.

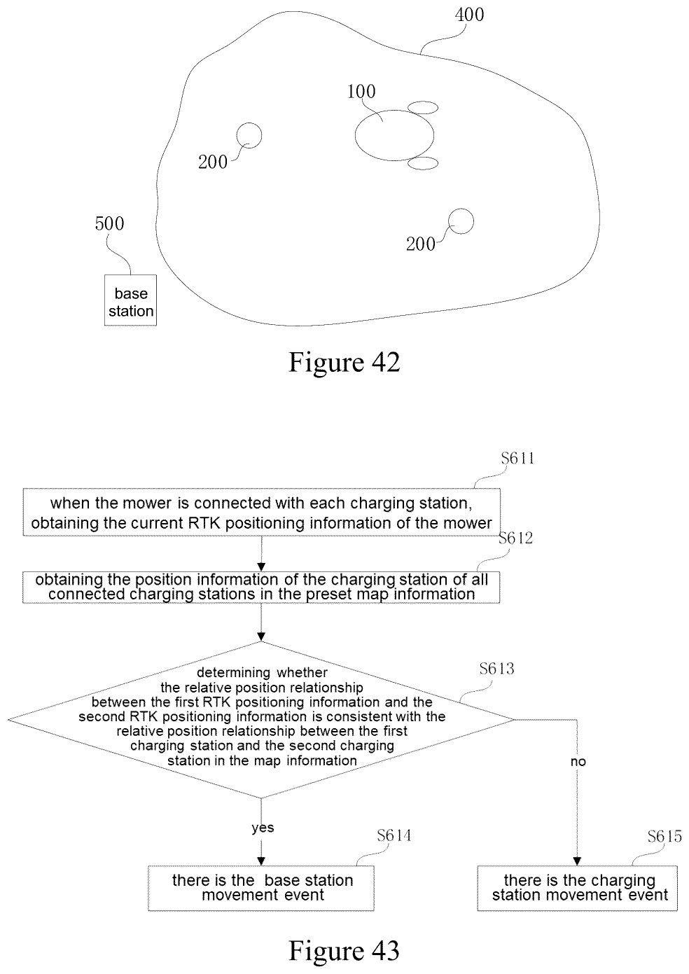

Please refer to FIG. 42 through FIG. 44. In another embodiment, the charging station access event includes accessing a plurality of charging stations in sequence.

S611: when the mower is connected with each charging station, the current RTK positioning information of the mower is obtained. For example, when the mower is connected with two charging stations in sequence, first RTK positioning information is obtained when the mower is connected with a first charging station, and second RTK positioning information is obtained when the mower is connected with a second charging station.

S612: the position information of the charging stations of all connected charging stations in the preset map information is obtained.

S613: whether a relative position relationship between the first RTK positioning information and the second RTK positioning information is consistent with a relative position relationship between the first charging station and the second charging station in the map information is determined.

S614: when the relative position relationship between the first RTK positioning information and the second RTK positioning information is consistent with a relative position relationship between the first charging station and the second charging station in the map information, the base station movement event is determined.

S615: when a relative position relationship between the first RTK positioning information and the second RTK positioning information is not consistent with a relative position relationship between the first charging station and the second charging station in the map information, the charging station movement event is determined.

It may be understood that, this embodiment is applicable to a case where there are plurality of charging stations in the working area as shown in FIG. 42. The mower can determine whether the base station or the charging station is offset based on the relative position changes of each charging station, without a need for the user to manually input offset information of the base station or the charging station.

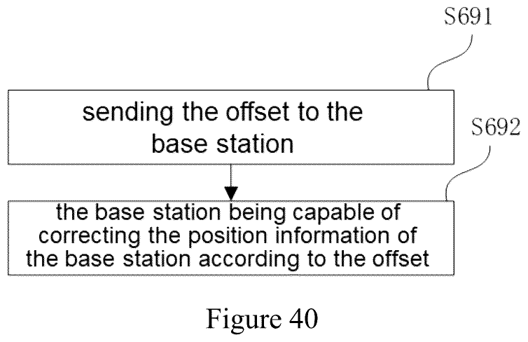

Please refer to FIG. 40. In a specific embodiment, after saving the offset, the following operations are further included.

S691: the offset is sent to the base station.

S692: the base station can correct the position information of the base station according to the offset.

In a specific embodiment, the input information is input information of the mobile terminal received by a wireless communication module. The mobile terminal may be, for example, a mobile phone or a mobile computer.

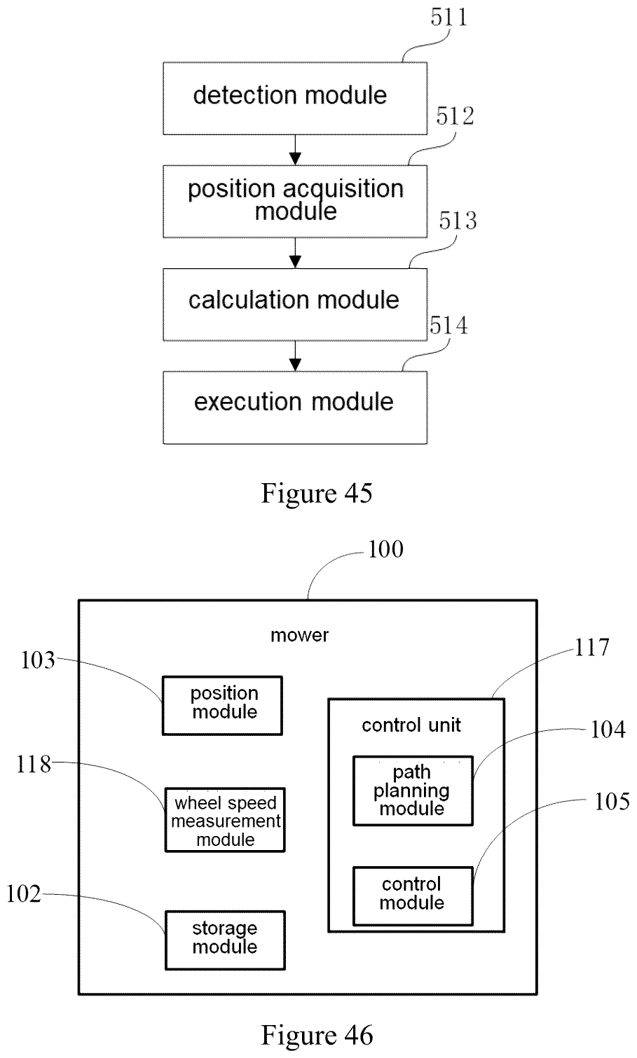

Based on the calibration method of the navigation information of the above-mentioned mower, the disclosure further provides a navigation information calibration device of the mower as shown in FIG. 45, the navigation information calibration device includes a detection module 511, a position acquisition module 512, a calculation module 513 and an execution module 514. The detection module 511 is used to detect the charging station access event. The position acquisition module 512 is used to obtain the current RTK positioning information of the mower and obtain the positioning information of the charging station from the preset map information. The calculation module 513 is used to calculate the offset between the RTK positioning information and the positioning information of the charging station. The execution module 514 is used to determine whether there is the base station movement event or the charging station movement event when the offset is greater than the preset threshold. When there is the base station movement event, the offset is saved, or the positions of all points in the map information is translated as a whole according to the offset, so that the position information of the charging station in the map information is consistent with the RTK positioning information. When there is the charging station movement event, the position information of the charging station in the map information is separately translated according to the offset, so that the position information of the charging station is consistent with the RTK positioning information.

Since other points on the map cannot be matched, while the positions of the charging station and the mower may be relatively fixed, when the mower is on the charging station, the disclosure may detect that when the position of the mower is offset by more than a certain threshold, and the user may be reminded that the map is offset and the map is unavailable. If it is confirmed that the charging station do not moved, all points on the map are offset, or the base station point is offset to obtain a workable map. The disclosure improves efficiency of mapping after the mower base station is moved and reduces cost of re-collecting maps.

A more autonomous control method of the mower requires the mower to have an accurate determination of its position so that the mower can move in the straight line to accurately mow. Due to an accumulation of errors in a transmission process of a mechanical structure itself, a distances traveled by the two wheels at the same time are inconsistent, causing the mower to deviate from the straight line, thereby affecting its mowing process. A control program of the mower still drives the mower with the same driving motor rotating speed of the two wheels of the mower, which is bound to cause the mower to deviate from its predetermined route.

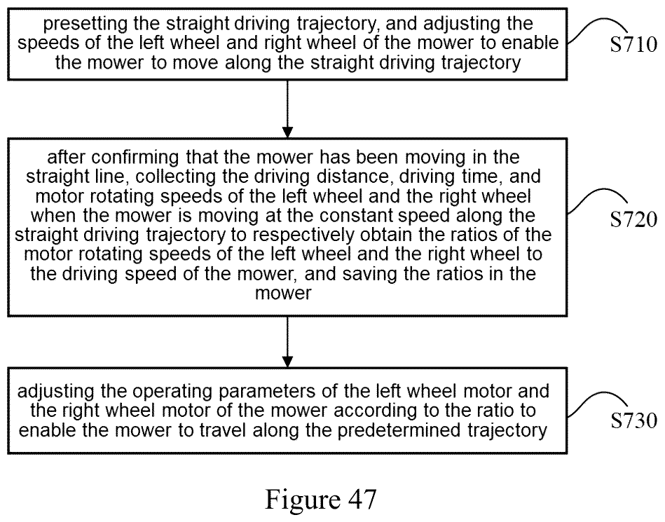

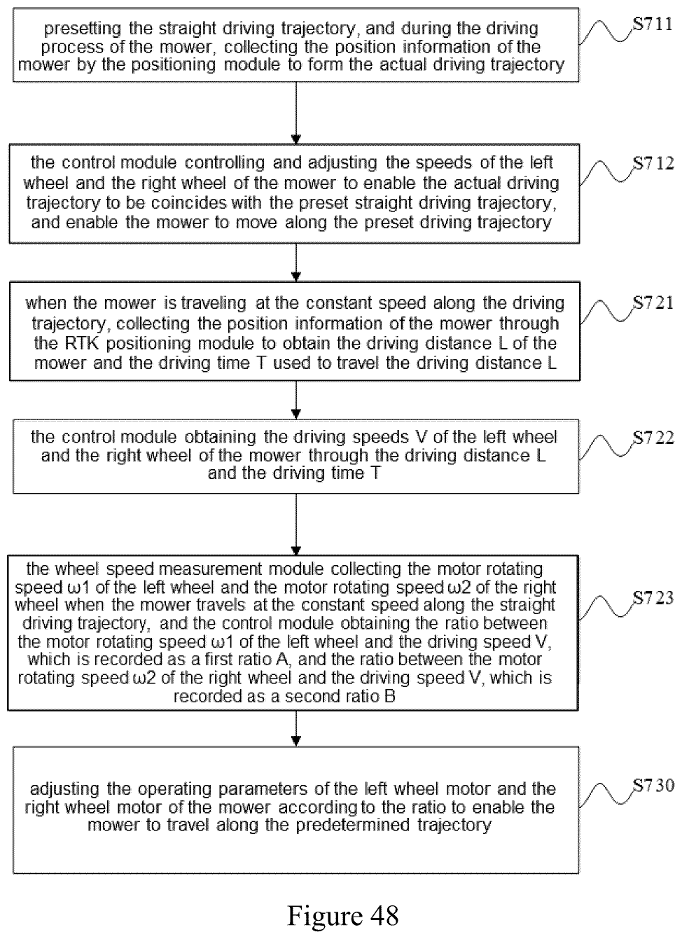

Based on this, please refer to FIG. 46, FIG. 47 and FIG. 48. The disclosure provides the mower and a calibration method thereof, which can eliminate an influence of manufacturing deviation so that the mower can move along a predetermined path. In an embodiment, the mower 100 includes a casing, a left wheel 121, a right wheel 122 and a control unit 117. The left wheel 121 and the right wheel 122 are installed on two sides of the casing to facilitate the movement of the mower. The control unit 117 is electrically connected with the left wheel 121 and the right wheel 122. The control unit 117 controls a speed of the driving motors of the left wheel 121 and the right wheel 122, thereby controlling an actual driving speed of the left wheel 121 and the right wheel 122 of the mower.

Please refer to FIG. 46. In this embodiment, the mower 100 further includes the positioning module 103 and a wheel speed measurement module 118. Specifically, the positioning module 103 is installed on the casing, and the positioning module 103 is used to collect the position information of the mower 100. It should be noted that the positioning module 103 is the RTK positioning module, and the positioning module collects the position information of the mower once every preset time. The preset time is set to, for example, 0.1 s, 1 s, 2 s or other time intervals, and may be adjusted according to actual needs. The RTK positioning module can uses the RTK differential information of the wireless receiving base station to achieve the accurate positioning.

Please refer to FIG. 46. In this embodiment, the wheel speed measurement module 118 is also installed on the casing, and is used to collect a motor rotating speed ω1 of a left wheel motor and a motor rotating speed @2 of a right wheel motor of the mower, and store collected data in the storage module 102.

Please refer to FIG. 46. In this embodiment, the control unit 117 includes the control module 105, which is connected with the positioning module 103 and the wheel speed measurement module 118. In this embodiment, the control module 105 is used to kinematically control and adjust the speed of the left wheel 121 and the right wheel 122 of the mower so that the mower 100 travels along a preset driving trajectory.

Wherein, the control module 105 further collects a driving distance L and driving time T of the mower 100 when it moves at a constant speed along a straight driving trajectory to obtain a driving speed V of the mower. In this embodiment, the preset driving trajectory is the straight driving trajectory, so as to facilitate a subsequent acquisition of the driving distance L and driving time T of the mower along the preset driving trajectory, thereby obtaining driving speeds V of the left wheel and the right wheel of the mower.

Please refer to FIG. 46. In this embodiment, the control module 105 compares a motor rotating speed of the left wheel motor and a motor rotating speed of the right wheel with the driving speed of the mower, and adjusts operating parameters of the left wheel motor and the right wheel motor under other moving trajectories according to a ratio obtained in a straight moving mode, so as to obtain a desired wheel driving speed, thereby controlling the mower to walk along a predetermined track. Specifically, the control module 105 obtains ratios of the motor rotating speed ω1 of the left wheel motor and the motor rotating speed ω2 of the right wheel motor to the driving speed V of the mower, and controls and adjusts the operating parameters of the left wheel motor and the right wheel motor according to the ratio between the motor rotating speed ω1 of the left wheel motor and the driving speed V of the mower and the ratio between the motor rotating speed ω2 of the right wheel motor and the driving speed V of the mower to obtain the desired actual driving speed of the left wheel 121 and the right wheel 122, so as to control the mower to mow along the planned path, thereby improving an accuracy of path planning control and reducing calibration costs.

Please refer to FIG. 46. In this embodiment, the control unit 117 further includes the path planning module 104, which is connected with the positioning module 103 and is used to generate an actual driving trajectory of the mower according to the position collected by the positioning module 103, and to determine whether the actual driving trajectory of the mower coincides with a preset straight driving trajectory, so as to collect the driving distance L and driving time T of the mower when it travels at a constant speed along the straight driving trajectory, and improve an accuracy of data collection.

It should be noted that, the path planning module 104 is further used to plan the working path in the working area where the mower is to work when the mower is mowing, so that the mower can subsequently mows along the planned working path. During the mowing, the control module 105 controls the actual driving speeds of the left wheel 121 and the right wheel 122 of the mower according to the ratio between the motor rotating speed ω1 of the left wheel motor and the driving speed V of the mower and the ratio between the motor speed ω2 of the right wheel motor and the driving speed V of the mower, so that the mower always mows along the planned working path, thereby improving the accuracy of path planning control.

Please refer to FIG. 46. In this embodiment, the calibration device 20 further includes the storage module 102, which is installed on the casing. The storage module 102 is connected with the positioning module 103, the wheel speed measurement module 118, the control module 105 and the path planning module 104, and is used to store the driving speed V of the mower, the position information of the mower, the motor rotating speed ω1 of the left wheel motor, the motor rotating speed ω2 of the right wheel motor, and the ratio between the motor rotating speed ω1 of the left wheel motor and the driving speed V of the mower and the ratio between the motor rotating speed ω2 of the right wheel motor and the driving speed V of the mower.

In addition, please refer to FIG. 46 through FIG. 50. When the mower 100 is traveling on a lawn grass surface, due to an error in a wheel diameter and an error in a size of a reduction gear, there is an error between an actual transmission ratio between the motor rotating speeds of the left and right wheel and an actual linear speed of the left and right wheels and an ideal transmission ratio, which causes the mower to deviate from the planned working path. Therefore, in order to enable the mower 100 to mow along the planned working path, it is necessary to accurately control the actual driving speeds of the left wheel 121 and the right wheel 122 so that the mower 100 can mow along the planned working path. In this embodiment, the speeds of the left wheel 121 and the right wheel 122 of the mower 100 are controlled by the control module 105 so that the mower 100 can mow along the planned working path.

The disclosure provides the mower and the calibration method thereof. The position of the mower is collected through the RTK positioning module, and then the path planning module is used to determine whether the movement path of the mower coincides with the planned working path, and the control module is used to control the speed of the left and right wheels of the mower so that the mower can mow along the planned working path, thereby improving the accuracy of the path planning control of the mower and working efficiency, and avoiding cost of calibration machinery and tools. In an embodiment, please refer to FIG. 47. In this embodiment, the calibration method of the mower includes operations as follows.

S710: the straight driving trajectory is preset, and the speeds of the left wheel and right wheel of the mower are adjusted so that the mower moves along the straight driving trajectory.

Please refer to FIG. 47 through FIG. 50. In S710, first, the straight driving trajectory is pre-set, and then the speed of the left wheel 121 and the right wheel 122 of the mower is controlled and adjusted by the control module 105 so that the mower moves along the straight driving trajectory. It should be noted that the mower uses a PID kinematic feedback adjustment algorithm to adjust the speed of the left wheel and the right wheel of the mower so that the mower moves along the straight driving trajectory. Specifically, by determining an offset direction between the mower and the straight driving trajectory, if an actual driving trajectory of the mower deviates to a right side relative to the straight driving trajectory, the speed of the right wheel 122 of the mower is controlled to increase. If the actual driving trajectory of the mower deviates to a left side relative to the straight driving trajectory, the speed of the left wheel 121 of the mower is controlled to increase. Until the driving trajectory of the mower coincides with the preset straight driving trajectory, it is determined that the mower is traveling along the straight driving trajectory. When the RTK positioning module detects that the offset distance of the actual trajectory of the mower relative to the preset trajectory is larger, the control unit controls a change rate of the motor rotating speed to be larger. When the RTK positioning module detects that the offset distance of the actual trajectory of the mower relative to the preset trajectory is smaller, the change rate of the motor speed is smaller, so that the actual trajectory of the mower finally moves in the straight line.

In an embodiment, please refer to FIG. 48. Pre-setting straight driving trajectory, and adjusting the speeds of the left wheel 121 and right wheel 122 of the mower to enable the mower to move along the straight driving trajectory includes operations as follows.

S711: the straight driving trajectory is preset, and during a driving process of the mower, the position information of the mower is collected by the positioning module 103 to form an actual driving trajectory.

S712: the control module 105 controls and adjusts the speeds of the left wheel 121 and the right wheel 122 of the mower so that the actual driving trajectory coincides with the preset straight driving trajectory, and the mower may move along the preset driving trajectory.

Wherein, in this embodiment, due to reasons such as processing and manufacturing accuracy, even if the motor rotating speed of the left wheel motor and the right wheel are the same, it is still possible that the speeds of the left wheel and the right wheel are inconsistent, causing the mower to deviate from the preset straight trajectory. It is necessary to adjust the speeds of the left wheel and the right wheel, and generate the actual driving trajectory of the mower through the path planning module 104 according to the position information collected by the positioning module 103. Through determining whether the actual driving trajectory of the mower coincides with the preset straight driving trajectory, it is determined whether the mower is driving along the preset straight driving trajectory. It should be noted that the positioning module 103 is the RTK positioning module, and the positioning module collects the position information of the mower once every preset time. The preset time is set to, for example, 0.1 s, 1 s, 2 s or other time intervals, and may be adjusted according to the actual needs. The PID control algorithm is used to adjust the motor rotating speeds of the left wheel and the right wheel. For example, when the RTK module detects that the mower is 10 cm to a left side of the preset trajectory, the left motor rotating speed is controlled to increase by 1%. As the left motor rotating speed increases, the direction of the mower changes. When the RTK module detects the position of the mower again, the mower is 1 cm to the left of the preset trajectory, and the left motor rotating speed is controlled to decrease by 0.5%. The above operations are repeated, and finally the mower moves in a straight line along the preset trajectory.

It should be noted that, in this embodiment, the preset driving trajectory is, for example, the straight driving trajectory, so as to control the mower to drive in the straight line, and to facilitate to subsequently obtain of the driving distance L and driving time T of the mower along the preset straight driving trajectory to obtain the driving speeds V of the left wheel and right wheel of the mower.

S720: after confirming that the mower has been moving in the straight line along the predetermined trajectory, the driving distance, driving time, and motor rotating speeds of the left wheel and the right wheel when the mower is moving at the constant speed along the straight driving trajectory are collected to respectively obtain the ratios of the motor rotating speeds of the left wheel and the right wheel to the driving speed of the mower, and the ratios are saved in the mower.

Please refer to FIG. 47 and FIG. 48. In S720, when it is confirmed that the mower is traveling at the constant speed along the preset straight driving trajectory, the position information collected by the positioning module 103 is used to obtain the driving distance L and driving time T of the mower when traveling at the constant speed along the straight driving trajectory, and the motor rotating speed ω1 of the left wheel and the motor rotating speed ω2 of the right wheel are collected by the wheel speed measurement module 118. The driving distance L, driving time T, the motor rotating speed ω1 of the left wheel and the motor rotating speed ω2 of the right wheel are stored in the storage module 102, so as to obtain the ratios of the motor rotating speed ω1 of the left wheel and the motor rotating speed ω2 of the right wheel to the driving speed V of the mower, respectively.

In an embodiment, please refer to FIG. 48. Obtaining the ratios of the motor rotating speed ω1 of the left wheel and the motor rotating speed ω2 of the right wheel to the driving speed V of the mower includes operations as follows.

S721: when it is confirmed that the mower is traveling at the constant speed along the straight driving trajectory, the position information of the mower is collected through the RTK positioning module to obtain the driving distance L of the mower and the driving time T used to travel the driving distance L.

In an embodiment, if it is determined that the mower does not deviate from the predetermined straight trajectory within a certain period of time, it may be confirmed that the mower is traveling along the straight trajectory.

S722: the control module 105 obtains the driving speeds V of the left wheel and the right wheel of the mower through the driving distance L and the driving time T. It should be noted that, in this embodiment, the preset driving trajectory is, for example, the straight driving trajectory. Since the mower travels along the preset straight driving trajectory, the driving distance L of the mower is a straight distance, which is easy to collect. At this time, the driving speeds of the left wheel 121 and the right wheel 122 of the mower are the same, which means the driving speed of the mower, that is, the driving speed V=L/T.

S723: the wheel speed measurement module 118 collects the motor rotating speed ω1 of the left wheel and the motor rotating speed ω2 of the right wheel when the mower travels at the constant speed along the straight driving trajectory, and the control module 105 obtains the ratio between the motor rotating speed ω1 of the left wheel and the driving speed V, which is recorded as a first ratio A, and the ratio between the motor rotating speed ω2 of the right wheel and the driving speed V, which is recorded as a second ratio B. That is, the motor rotating speed of the left wheel and the right wheel are obtained when the left wheel and the right wheel are at the same speed, so as to achieve a purpose of calibration.

S730: the operating parameters of the left wheel motor and the right wheel motor of the mower are adjusted according to the ratio, so that the mower travels along the predetermined trajectory.

Please refer to FIG. 47 and FIG. 48. In S730, the operating parameters of the left wheel motor and the right wheel motor of the mower are adjusted according to the ratio, so that the mower travels along the predetermined trajectory. Specifically, the ratio is the first ratio A and the second ratio B stored in the mower, and the working path is planned through the working area map in the mower in which the ratios are stored. It should be noted that the planned working path may be the working path pre-planned in the working area by the path planning module 104 before the mower starts working, or it may be a directly downloaded working area map with the planned working path.

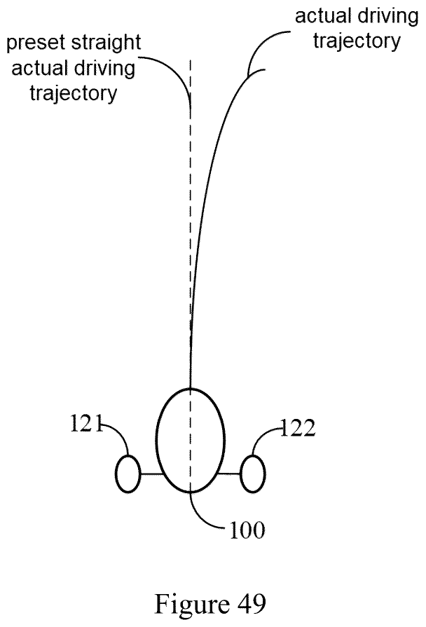

Please refer to FIG. 48 and FIG. 49. In S730, the actual driving speeds of the left wheel 121 and the right wheel 122 of the mower are adjusted according to the ratio of the motor rotating speed ω1 of the left wheel motor to the driving speed V of the mower and the ratio of the motor rotating speed ω2 of the right wheel motor to the driving speed V of the mower, so that the mower travels along the working path. Specifically, operating parameters of the left wheel motor and the right wheel motor of the mower are adjusted according to the first ratio A and the second ratio B, such as adjusting the motor rotating speed, so as to adjust the actual driving speeds of the left wheel 121 and the right wheel 122 of the mower, so that the mower travels along the predetermined trajectory. For example, when the mower is traveling along the working path pre-planned by the path planning module 104 within the working area, when the actual driving path of the mower deviates from the planned working path, the speed of the left wheel 121 of the mower may be kinematically adjusted according to the first ratio A between the motor rotating speed ω1 of the left wheel motor and the driving speed V, and/or the speed of the right wheel 122 of the mower may be kinematically adjusted according to the second ratio B between the motor rotating speed ω2 of the right wheel motor and the driving speed V, so that the mower can mow along the planned working path, thereby improving the accuracy of the path planning control of the mower and the working efficiency, and the avoiding cost of calibrating machinery and tools.

It should be noted that, the working path pre-planned by the path planning module 104 in the working area may be a straight line or a curve line. During driving, the position information of the mower is collected through the positioning module 103, and the actual driving path of the mower is formed through the path planning module 104 to determine whether the mower deviates from the pre-planned working path.

The disclosure provides the mower and the calibration method thereof. The position of the mower is collected through the RTK positioning module, and then the path planning module is used to determine whether the movement path of the mower coincides with the planned working path, and the control module is used to control the speed of the left and right wheels of the mower so that the mower can mow along the planned working path, thereby improving the accuracy of the path planning control of the mower and working efficiency, and avoiding the cost of calibration machinery and tools.

It is obvious to those skilled in the art that the disclosure is not limited to the details of the above-described exemplary embodiments, and that the disclosure can be implemented in other specific forms without departing from the essential characteristics of the disclosure.

The above embodiments are only used to illustrate the technical solutions of the disclosure and not to limit it. Although the disclosure has been described in detail with reference to the preferred embodiments, those of ordinary skill in the art should understand that the technical solutions of the disclosure may be modified or equivalently replaced without departing from the scope of the technical solution of the disclosure.

What is claimed is:

1. A control method of a garden tool, comprising:
obtaining a working area map of the garden tool, the working area map including a satellite navigation shadowed area, and a target marker identified by an identification scanning module being arranged in the satellite navigation shadowed area;
reliable shadowed area positioning the garden tool based on a satellite navigation signal and the working area map when the garden tool is in an area with reliable satellite signals outside the satellite navigation shadowed area; and
shadowed area positioning the garden tool through identifying the target marker in the satellite navigation shadowed area through the identification scanning module when the garden tool is in the satellite navigation shadowed area.

2. The control method of the garden tool according to claim 1, wherein a plurality of the target markers being identified by the identification scanning module is arranged in the satellite navigation shadowed area, and the plurality of the target markers is arranged according to a preset position relationship;
shadowed area positioning the garden tool through identifying the target marker in the satellite navigation shadowed area through the identification scanning module when the garden tool is in the satellite navigation shadowed area comprising:
when the garden tool enters the satellite navigation shadowed area, based on the preset position relationship, identifying the target marker by the identification scanning module to obtain a first position and first distance data of the target marker relative to the garden tool; and
calculating position information of the garden tool according to the first position and the first distance data of the target marker relative to the garden tool and according to the position information of the target marker to position the garden tool in the satellite navigation shadowed area.

3. The control method of the garden tool according to claim 2, wherein, when the garden tool enters the satellite navigation shadowed area, based on the preset position relationship, identifying the target marker by the identification scanning module to obtain a first position and first distance data of the target marker relative to the garden tool comprising:
obtaining first positions and first distance data of a plurality of obstacles comprising the target marker relative to the garden tool through the identification scanning module;
calculating a position relationship between the obstacles according to the first positions and the first distance data of the plurality of the obstacles relative to the garden tool; and
based on the position relationship between the obstacles, searching for several obstacles satisfying the preset position relationship from the plurality of the obstacles as the target markers.

4. The control method of the garden tool according to claim 2, wherein, three target markers identified by the identification scanning module are arranged in the satellite navigation shadowed area, the three target markers are arranged in a triangle, and the preset position relationship refers to a distance between any two of the target markers.

5. The control method of the garden tool according to claim 1, wherein, the working area map further comprises marker matching areas, each of the marker matching areas is arranged around a periphery of the satellite navigation shadowed area;
and in the satellite navigation shadowed area, positioning the garden tool through identifying the target marker in the satellite navigation shadowed area through the identification scanning module comprising:
scanning a surrounding environment of the garden tool through the identification scanning module to obtain scanning information;
matching the scanning information with marker feature information in the marker matching area corresponding to the satellite navigation shadowed area to identify the target marker in the satellite navigation shadowed area; and
positioning the garden tool in the satellite navigation shadowed area based on the identified target marker.

6. The control method of the garden tool according to claim 5, wherein, positioning the garden tool in the satellite navigation shadowed area based on the identified target marker comprising:
obtaining a second position and second distance data of the identified target marker relative to the garden tool through the identification scanning module; and
estimating a position of the garden tool in the satellite navigation shadowed area based on the second position and second distance data of the identified target marker relative to the garden tool and based on position information of the identified target marker to achieve a positioning of the garden tool in the satellite navigation shadowed area.

7. The control method of the garden tool according to claim 5, wherein, the marker matching area is a rectangular marker matching area or a circular marker matching area.

8. The control method of the garden tool according to claim 5, further comprising:
when the garden tool enters the marker matching area, the garden tool entering a ready state;
the garden tool obtaining a relative position of the target marker based on the position information of the target marker in the marker matching area and based on position information of the garden tool;
when the garden tool moves further and enters the satellite navigation shadowed area in the marker matching area, obtaining a predicted position of the target marker based on the relative position of the target marker and based on a moving direction and a speed of the garden tool;
scanning a preset range on two sides of the predicted position through the identification scanning module to obtain the scanning information;
matching the scanning information with marker feature information in the marker matching area to identify the target marker in the satellite navigation shadowed area; and
positioning the garden tool in the satellite navigation shadowed area based on the identified target marker.

9. The control method of the garden tool according to claim 1, further comprising:
based on the working area map, controlling the garden tool to walk around an edge of a satellite navigation shadowed area, collecting and saving position information of the satellite navigation shadowed area, and identifying the satellite navigation shadowed area in the working area map.

10. The control method of the garden tool according to claim 1, wherein, in the area with reliable satellite signals outside the satellite navigation shadowed area, positioning the garden tool based on the satellite navigation signal and the working area map comprising:
in the area with reliable satellite signals outside the satellite navigation shadowed area, controlling a movement of the garden tool based on a real-time kinematic differential positioning signal and the working area map.

11. The control method of the garden tool according to claim 1, further comprising:
in the area with reliable satellite signals outside the satellite navigation shadowed area, identifying the target marker through the identification scanning module to obtain a third position and third distance data of the target marker relative to the garden tool; and
calculating position information of the target marker according to the third position and the third distance data of the target marker relative to the garden tool and according to position information of the garden tool.

12. The control method of the garden tool according to claim 1, wherein, the identification scanning module comprises a visual recognition module or a radar recognition module, and the radar recognition module comprises a laser radar recognition module or a millimeter wave radar module.

13. The control method of the garden tool according to claim 1, wherein, the garden tool comprises mowers or snow throwers.

14. A control system of a garden tool, comprising:
a map acquisition module, the map acquisition module configured to obtain a working area map of the garden tool, a satellite navigation shadowed area being marked in the working area map, and a target marker identified by an identification scanning module being arranged in the satellite navigation shadowed area;
a satellite positioning module, the satellite positioning module configured to position the garden tool based on a satellite navigation signal and the working area map in an area with reliable satellite signals outside the satellite navigation shadowed area; and
a shadowed area positioning module, the shadowed area positioning module configured to position the garden tool through identifying the target marker in the satellite navigation shadowed area through the identification scanning module in the satellite navigation shadowed area.

15. The control system of the garden tool according to claim 14, wherein, a plurality of the target markers identified by the identification scanning module are arranged in the satellite navigation shadowed area, and the plurality of the target markers are arranged according to a preset position relationship; and
the shadowed area positioning module comprises:
a first identification module, the first identification module configured to identify the target marker by the identification scanning module to obtain a first position and first distance data of the target marker relative to the garden tool based on the preset position relationship when the garden tool enters the satellite navigation shadowed area; and
a first position calculation module, the first position calculation module configured to calculate position information of the garden tool according to the first position and the first distance data of the target marker relative to the garden tool and according to position information of the target marker to position the garden tool in the satellite navigation shadowed area.

16. The control system of the garden tool according to claim 14, wherein, the working area map is further marked with marker matching areas, each of the marker matching areas is arranged around a periphery of the satellite navigation shadowed area, and the shadowed area positioning module comprises:
a scanning information acquisition module, the scanning information acquisition module configured to scan a surrounding environment of the garden tool through the identification scanning module to obtain scanning information;
a second identification module, the second identification module configured to match the scanning information with marker feature information in the marker matching area corresponding to the satellite navigation shadowed area to identify the target marker in the satellite navigation shadowed area; and
a second position calculation module, the second position calculation module configured to position the garden tool in the satellite navigation shadowed area based on the identified target marker.

17. A garden tool, comprising:
a storage module, the storage module configured to store a working area map of the garden tool;
a positioning module, the positioning module configured to position the garden tool based on a satellite navigation signal;
an identification scanning module, the identification scanning module configured to recognize a target marker and obtain a position and a distance of the target marker relative to the garden tool; and
a control module, the control module configured to:
obtain the working area map of the garden tool, a satellite navigation shadowed area being marked in the working area map, and a target marker identified by an identification scanning module being arranged in the satellite navigation shadowed area;
position the garden tool based on the satellite navigation signal and the working area map in an area with reliable satellite signals outside the satellite navigation shadowed area; and
position the garden tool through identifying the target marker in the satellite navigation shadowed area through the identification scanning module in the satellite navigation shadowed area.

18. The garden tool according to claim 17, wherein, the identification scanning module comprises a visual recognition module or a radar recognition module, and the radar recognition module comprises a laser radar recognition module or a millimeter wave radar module.

19. The garden tool according to claim 17, wherein, the garden tool further comprises a path planning module, and the path planning module is configured to plan a path according to the working area map of the garden tool.

20. The garden tool according to claim 17, wherein, the garden tool comprises mowers or snow throwers.
